(19) United States
(12) Patent Application Publication
(10) Pub. No.: US 2026/0188250 A1
(43) Pub. Date: Jul. 2, 2026

(54) ELECTRONIC DEVICE

(71) Applicant: Samsung Display Co., Ltd., Yongin-si (KR)

(72) Inventors: Junhyun PARK, Yongin-si (KR); Sunkwun SON, Yongin-si (KR); Cheol-Gon LEE, Yongin-si (KR); Nahyeon CHA, Yongin-si (KR)

(73) Assignee: Samsung Display Co., Ltd., Yongin-si (KR)

(21) Appl. No.: 19/379,173

(22) Filed: Nov. 4, 2025

(30) Foreign Application Priority Data
Jan. 2, 2025 (KR) 10-2025-0000463

(51) Int. Cl. G09G 3/3266; G09G 3/3225

(52) U.S. Cl. CPC G09G 3/3266; G09G 3/3225; G09G 2300/0426; G09G 2310/0286; G09G 2310/08

(57) ABSTRACT

An electronic device is provided. The electronic device includes: a plurality of scan stages, wherein a first scan stage of the plurality of scan stages is configured to receive a logic clock signal, a clock signal, and a carry signal, and output a scan signal; and a plurality of clock lines connected to the plurality of scan stages, respectively. The plurality of clock lines include a logic clock line configured to provide the logic clock signal to the first scan stage and a scan clock line configured to provide the clock signal to the first scan stage, and when viewed in a plan view, the logic clock line overlaps the plurality of scan stages, and the scan clock line is offset from the plurality of scan stages.

### CROSS-REFERENCE TO RELATED APPLICATION

This application claims priority under 35 U.S.C. § 119 to Korean Patent Application No. 10-2025-0000463, filed on January 2, 2025, in the Korean Intellectual Property Office, the disclosure of which is incorporated by reference herein in its entirety.

### BACKGROUND

The present disclosure relates to an electronic device with improved reliability.

Multimedia electronic devices, such as a television, a cellular phone, a tablet personal computer (PC), a computer, navigation, or a game console, include a display panel to display an image. Recently, studies and researches have been conducted to reduce a region (a non-display region or a bezel region), in which an image is not displayed, from a display panel, to meet a user demand.

### SUMMARY

One or more embodiments provide an electronic device improved in reliability.

One or more embodiments also provide an electronic device having a non-display region reduced in area.

According to an aspect of an embodiment, an electronic device includes: a display panel; and a processor configured to control the display panel. The display panel includes: a plurality of pixels connected to a plurality of data lines and a plurality of scan lines, respectively; a plurality of scan stages connected to the plurality of scan lines, respectively; and a plurality of clock lines connected to the plurality of scan stages, respectively. The plurality of pixels are configured to receive a corresponding data voltage, in response to a corresponding scan signal. A first scan stage of the plurality of scan stages is configured to receive a logic clock signal, a clock signal, and a carry signal, and output a scan signal. The plurality of clock lines include a logic clock line configured to provide the logic clock signal and a scan clock line configured to provide the clock signal. The scan clock line is adjacent the plurality of scan stages along a first direction, when viewed in a plan view. The plurality of clock lines extend in a second direction crossing the first direction. The logic clock line is spaced apart from the scan clock line along the first direction, when viewed in the plan view.

The scan clock line may be offset from the plurality of scan stages, when viewed in the plan view.

The logic clock line may overlap the plurality of scan stages, when viewed in the plan view.

The logic clock line may be on the plurality of scan stages.

The logic clock signal may have a square waveform which oscillates between a turn-on voltage level and a turn-off voltage level at a specific cycle.

The plurality of scan stages may output the clock signal as the scan signal, in response to the carry signal.

The first scan stage may be further configured to output the logic clock signal as the carry signal to be provided to a second scan stage, of the plurality of scan stages, in response to the carry signal.

The logic clock line may be spaced apart from the plurality of scan stages in the first direction, and the scan clock line may be between the logic clock line and the plurality of scan stages, when viewed in the plan view.

The clock signal may include a first clock signal and a second clock signal different from the first clock signal. The scan clock line may include: a first scan clock line configured to provide the first clock signal; and a second scan clock line configured to provide the second clock signal.

The second scan clock line may be spaced apart from the plurality of scan stages, and the first scan clock line may be between the second scan clock line and the plurality of scan stages.

The second clock signal may have a waveform shifted by a specific period from the first clock signal.

According to another aspect of an embodiment, an electronic device includes: a plurality of scan stages, wherein a first scan stage of the plurality of scan stages is configured to receive a logic clock signal, a clock signal, and a carry signal, and output a scan signal; and a plurality of clock lines connected to the plurality of scan stages, respectively. The plurality of clock lines include a logic clock line configured to provide the logic clock signal to the first scan stage and a scan clock line configured to provide the clock signal to the first scan stage, and when viewed in a plan view, the logic clock line overlaps the plurality of scan stages, and the scan clock line is offset from the plurality of scan stages.

The logic clock line may be on the plurality of scan stages.

The logic clock signal may have a square waveform which oscillates between a turn-on voltage level and a turn-off voltage level at a specific cycle.

The first scan stage may be further configured to output the clock signal as the scan signal, in response to the carry signal.

The first scan stage may be further configured to output the logic clock signal as the carry signal to be provided to a second scan stage of the plurality of scan stages, in response to the carry signal.

The clock signal may include a first clock signal and a second clock signal different from the first clock signal.

The scan clock line may include: a first scan clock line configured to provide the first clock signal; and a second scan clock line configured to provide the second clock signal.

The second scan clock line may be spaced apart from the plurality of scan stages, and the first scan clock line may be between the second scan clock line and the plurality of scan stages.

The second clock signal may have a waveform shifted by a specific period from the first clock signal.

### BRIEF DESCRIPTION OF DRAWINGS

The above and other aspects will be more apparent from the following description of embodiments, taken in conjunction with the accompanying drawings.

FIG. 1 is a block diagram illustrating an electronic device according to embodiments.

FIG. 2 is a block diagram of a display panel and a display driver according to an embodiment.

FIG. 3 is a schematic equivalent circuit diagram of a pixel according to an embodiment.

FIG. 4 is a waveform diagram to describe the operation of a pixel according to an embodiment.

FIG. 5 is a block diagram illustrating a first driving circuit according to an embodiment.

FIG. 6 is a block diagram illustrating a second driving circuit according to an embodiment.

FIG. 7 is a schematic block diagram illustrating a first driving circuit according to an embodiment.

FIG. 8 is a schematic block diagram illustrating expanded region AA’ of a first driving circuit according to an embodiment.

FIG. 9 is a schematic equivalent circuit diagram illustrating a first scan stage according to an embodiment.

FIG. 10 is a waveform illustrating the driving of clock signals according to an embodiment.

FIG. 11 is a schematic block diagram illustrating expanded region AA’ of a first driving circuit according to an embodiment.

FIG. 12 is a schematic block diagram illustrating expanded region AA’ of a first driving circuit according to an embodiment.

FIG. 13 is a schematic equivalent circuit diagram illustrating a first scan stage according to an embodiment.

FIG. 14 is a waveform illustrating the driving of clock signals according to an embodiment.

FIG. 15 is a schematic block diagram illustrating expanded region AA’ of a first driving circuit according to an embodiment.

FIG. 16 is a block diagram illustrating an electronic device according to an embodiment.

FIG. 17 is a schematic view illustrating an electronic device according to various embodiments.

### DETAILED DESCRIPTION

Hereinafter, embodiments are described in detail with reference to the accompanying drawings. Embodiments described herein are example embodiments, and thus, the present disclosure is not limited thereto, and may be realized in various other forms. Each embodiment provided in the following description is not excluded from being associated with one or more features of another example or another embodiment also provided herein or not provided herein but consistent with the present disclosure.

In the specification, when a component, an element or layer is referred to as being “on,” “connected to” or “coupled to” another component, element or layer, it can be directly on, connected or coupled to the other component, element or layer, or intervening components, elements or layers may be present. By contrast, when an element is referred to as being “directly on,” “directly connected to” or “directly coupled to” another component, element or layer, there are no intervening components, elements or layers present.

The same reference numeral will be assigned to the same component. In addition, in drawings, thicknesses, proportions, and dimensions of components may be exaggerated to describe the technical features effectively. The term “and/or” includes any and all combinations of one or more of associated components

Although the terms “first”, or “second” may be used to describe various components, the components should not be construed as being limited by the terms. The terms are only used to distinguish one component from another component. For example, without departing from the scope and spirit of the present disclosure, a first component may be referred to as a second component, and similarly, the second component may be referred to as the first component. The singular forms are intended to include the plural forms unless the context clearly indicates otherwise.

In addition, the terms “under”, “at a lower portion”, “above”, “an upper portion” are used to describe the relationship between components illustrated in drawings. The terms are relative and will be described with reference to a direction indicated in the drawing.

It will be further understood that the terms “comprise,” “include,” or “including,” or “have” or “having” specify the presence of stated features, numbers, steps, operations, components, parts, or the combination thereof, but do not preclude the presence or addition of one or more other features, numbers, steps, operations, components, components, and/or the combination thereof.

The terms “part” and “unit” refer to a hardware component which may operate according to software instructions to perform a specific function. The hardware component may include field-programmable gate array (FPGA) or an application-specific integrated circuit (ASIC). The software instructions may refer to an executable code and/or data used by the executable code in an addressable storage medium. Accordingly, software instructions may be, for example, object-oriented software components, class components, and task components, and may include processes, functions, properties, procedures, subroutines, program code segments, driver data, firmware, microcodes, circuits, data, database, data structures, tables, arrangements or variables.

Unless defined otherwise, all terms (including technical terms and scientific terms) used in the specification have the same meaning as commonly understood by one skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly defined herein.

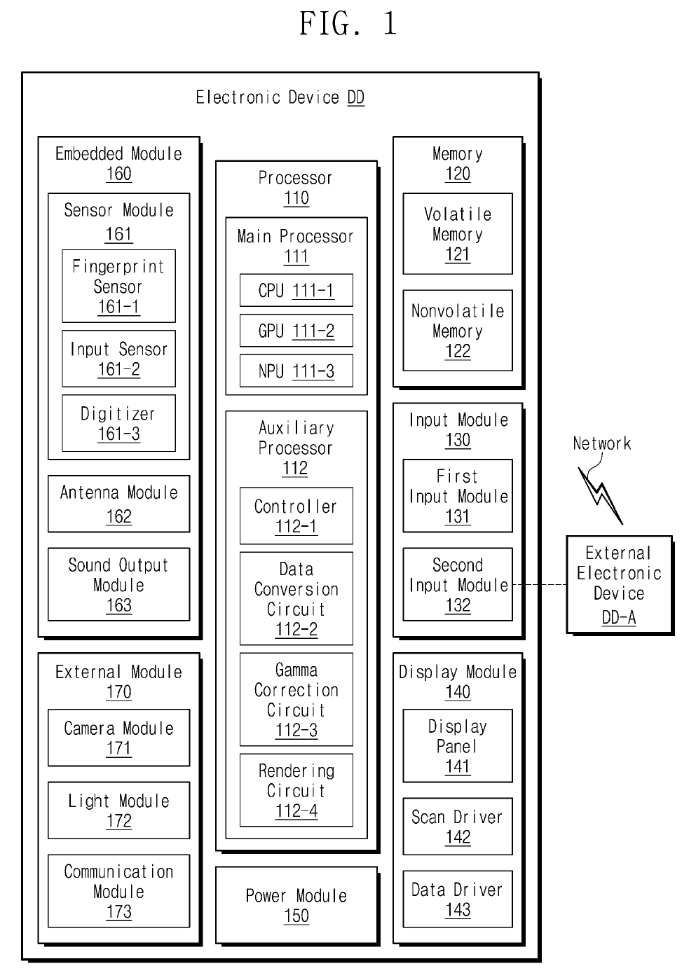

FIG. 1 is a block diagram illustrating an electronic device according to embodiments.

According to embodiments, electronic device DD may include processor 110, memory 120, input module 130, display module 140, power module 150, embedded module 160 and external module 170. The electronic device DD outputs a variety of information through the display module 140 in an operating system. When the processor 110 executes an application stored in the memory 120, the display module 140 provides a user with application information through a display panel 141.

The processor 110 obtains an external input through the input module 130 or a sensor module 161 and executes an application corresponding to the external input. For example, when the user selects a camera icon displayed on the display panel 141, the processor 110 obtains a user input through an input sensor 161-2 and activates a camera module 171. The processor 110 transfers image data corresponding to a photographed image obtained through the camera module 171 to the display module 140. The display module 140 may display an image corresponding to the photographed image through the display panel 141.

As another example, when authentication for personal information is performed in the display module 140, a fingerprint sensor 161-1 obtains input fingerprint information as input data. The processor 110 compares the input data obtained through the fingerprint sensor 161-1 with authentication data stored in the memory 120 and executes an application depending on a comparison result. The display module 140 may display information executed depending on logic of the application, through the display panel 141.

As another example, when the user selects a music streaming icon displayed on the display module 140, the processor 110 obtains the user input through the input sensor 161-2 and activates a music streaming application stored in the memory 120. When a music play command is input to the music streaming application, the processor 110 activates a sound output module 163 and provides the user with sound information corresponding to the music play command.

The operation of the electronic device DD has been briefly described above. Below, a configuration of the electronic device DD will be described in detail. Some of components of the electronic device DD to be described later may be implemented integrally into one component, and the one component may be divided into two or more components.

Referring to FIG. 1, the electronic device DD may communicate with an external electronic device DD-A over a network (e.g., a short-range wireless communication network or a long-range wireless communication network). According to an embodiment, the electronic device DD may include the processor 110, the memory 120, the input module 130, the display module 140, the power module 150, the embedded module 160, and the external module 170. According to an embodiment, the electronic device DD may not include at least one of the above components or may further include at least one different component. According to an embodiment, some of the above components (e.g., the sensor module 161, an antenna module 162, or the sound output module 163) may be integrated into any other component (e.g., the display module 140).

The processor 110 may execute software to control at least one component (e.g., a hardware or software component) of the electronic device DD connected to the processor 110 and may perform various data processing or operations. According to an embodiment, as at least a part of the data processing or operations, the processor 110 may store a command or data received from any other component (e.g., the input module 130, the sensor module 161, or a communication module 173) in a volatile memory 121, may process the command or data stored in the volatile memory 121, and may store the processed data in a nonvolatile memory 122.

The processor 110 may include a main processor 111 and an auxiliary processor 112. The main processor 111 may include at least one of a central processing unit (CPU) 111-1 or an application processor (AP). The main processor 111 may further include at least any one of a graphic processing unit (GPU) 111-2, a communication processor (CP), and an image signal processor (ISP). The main processor 111 may further include a neural processing unit (NPU) 111-3. The neural processing unit 111-3 may be a processor specialized for processing of an artificial intelligence model, and the artificial intelligence model may be created through machine learning. The artificial intelligence model may include a plurality of artificial neural network layers. The artificial neural network may include one of a deep neural network (DNN), a convolutional neural network (CNN), a recurrent neural network (RNN), a restricted boltzmann machine (RBM), a deep belief network (DBN), a bidirectional recurrent deep neural network (BRDNN), a deep Q-network, or a combination of at least two thereof, but embodiments are not limited thereto. Additionally or alternatively, the artificial intelligence model may include a software structure in addition to a hardware structure. At least two of the above processing units and processors may be implemented integrally into one component (e.g., a single chip), or each of the above processing units and processors may be implemented in the form of an independent component (e.g., a plurality of chips).

The auxiliary processor 112 may include a controller 112-1. The controller 112-1 may include an interface conversion circuit and a timing control circuit. The controller 112-1 receives an image signal from the main processor 111 and outputs image data obtained by converting a data format of the image signal to conform to a specification of an interface with the display module 140. The controller 112-1 may output various kinds of control signals necessary to drive the display module 140.

The auxiliary processor 112 may further include a data conversion circuit 112-2, a gamma correction circuit 112-3, and a rendering circuit 112-4. The data conversion circuit 112-2 may receive image data from the controller 112-1, and may compensate for the image data such that an image is displayed with a desired brightness depending on a characteristic of the electronic device DD or user settings or may convert the image data to reduce power consumption or to compensate for an afterimage. The gamma correction circuit 112-3 may convert the image data or a gamma reference voltage such that an image displayed on the electronic device DD has a desired gamma characteristic. The rendering circuit 112-4 may receive the image data from the controller 112-1 and may render the image data in consideration of a pixel arrangement of the display panel 141 applied to the electronic device DD. At least one of the data conversion circuit 112-2, the gamma correction circuit 112-3, and the rendering circuit 112-4 may be integrated into any other component (e.g., the main processor 111 or the controller 112-1). At least one of the data conversion circuit 112-2, the gamma correction circuit 112-3, and the rendering circuit 112-4 may be integrated into a data driver 143 to be described later.

The memory 120 may store various data used by at least one component (e.g., the processor 110 or the sensor module 161) of the electronic device DD and input data or output data for a command related thereto. The memory 120 may include at least one of the volatile memory 121 and the nonvolatile memory 122.

The input module 130 may receive a command or data to be used by a component (e.g., the processor 110, the sensor module 161, or the sound output module 163) of the electronic device DD from the outside of the electronic device DD (e.g., the user or the external electronic device DD-A).

The input module 130 may include a first input module 131 to receive a command or data from the user and a second input module 132 to receive a command or data from the external electronic device DD-A. The first input module 131 may include a microphone, a mouse, a keyboard, a key (e.g., a button), or a pen (e.g., a passive pen or an active pen). The second input module 132 may support a specified protocol capable of connecting to the external electronic device DD-A by wire or wirelessly. According to an embodiment, the second input module 132 may include a high definition multimedia interface (HDMI), a universal serial bus (USB) interface, a secure digital (SD) card interface, or an audio interface. The second input module 132 may include a connector, such as an HDMI connector, a USB connector, an SD card connector, or an audio connector (e.g., a headphone connector), which is capable of being physically connected to the external electronic device DD-A.

The display module 140 visually provides information to the user. The display module 140 may include the display panel 141, a scan driver 142, and the data driver 143. The display module 140 may further include a window, a chassis, and a bracket to protect the display panel 141.

The display panel 141 may include a liquid crystal display panel, an organic light emitting display panel, or an inorganic light emitting display panel, and the type of the display panel 141 is not particularly limited. The display panel 141 may be of a rigid type or may be of a flexible type capable of being rolled or folded. The display module 140 may further include a supporter supporting the display panel 141, a bracket, or a heat radiation member.

The scan driver 142 serving as a driving chip may be mounted in the display panel 141. In addition, the scan driver 142 may be integrated into the display panel 141. For example, the scan driver 142 may include an amorphous silicon (ASG) TFT gate driver circuit, a low temperature polycrystalline silicon (LTPS) TFT gate driver circuit, or an oxide semiconductor (OSG) TFT gate driver circuit provided in the display panel 141. The scan driver 142 receives a control signal from the controller 112-1, and output scan signals to the display panel 141 in response to the control signal.

The display panel 141 may further include a light emitting driver. The light emitting driver outputs an emission control signal to the display panel 141, in response to the control signal received from the controller 112-1. The light emitting driver may be formed separately from the scan driver 142 or may be integrated into the scan driver 142.

The data driver 143 receives a data control signal from the controller 112-1. After converting image data into an analog voltage (e.g., a data voltage) in response to the control signal, the data driver 143 outputs data voltages to the display panel 141.

The data driver 143 may be integrated into a different component (e.g., the controller 112-1). The functions of the interface conversion circuit and the timing control circuit of the controller 112-1 described above may be integrated into the data driver 143.

The display module 140 may further include a light emitting driver, and a voltage generation circuit. The voltage generation circuit may output various types of voltages necessary to drive the display panel 141.

The power module 150 supplies a power to the components of the electronic device DD. The power module 150 may include a battery which charges a power supply voltage. The battery may include a primary cell not rechargeable, a secondary cell rechargeable, or a fuel cell. The power module 150 may include a power management integrated circuit (PMIC). The PMIC supplies power optimized for each of the modules described above and modules to be described later. The power module 150 may include a wireless power transmission/reception member electrically connected to the battery. The wireless power transmission/reception member may include a plurality of antenna radiators that are in the form of a coil.

The electronic device DD may further include the embedded module 160 and the external module 170. The embedded module 160 may include the sensor module 161, the antenna module 162, and the sound output module 163. The external module 170 may include the camera module 171, a light module 172, and the communication module 173.

The sensor module 161 may sense an input by a user body or an input by a pen in the first input module 131 and may generate an electrical signal or a data value corresponding to the input. The sensor module 161 may include at least one of the fingerprint sensor 161-1, the input sensor 161-2, and a digitizer 161-3.

The fingerprint sensor 161-1 may generate a data value corresponding to the user fingerprint. The fingerprint sensor 161-1 may include one of an optical fingerprint sensor or a capacitive fingerprint sensor.

The input sensor 161-2 may generate a data value corresponding to coordinate information of the input by the user body or the input by the pen. The input sensor 161-2 generates a change in capacitance, which is made due to the input, in the form of a data value. The input sensor 161-2 may sense the input by the passive pen or may exchange data with the active pen.

The input sensor 161-2 may measure a biometric signal, such as blood pressure, moisture, or body fat. For example, when the user touches a user body part to a sensor layer or a sensing panel without moving for a specific period of time, the input sensor 161-2 may sense the biometric signal based on a change in an electric field caused by the body part and may output the information based on the sensed biometric signal to the display module 140.

The digitizer 161-3 may generate a data value corresponding to the coordinate information of the input by the user body or the pen. The digitizer 161-3 generates a data value based on an electromagnetic change, which is induced by the input. The digitizer 161-3 may sense the input by the passive pen or may exchange data with the active pen.

At least one of the fingerprint sensor 161-1, the input sensor 161-2, and the digitizer 161-3 may be implemented in the form of a sensor layer, which is formed on the display panel 141, through subsequent processes. The fingerprint sensor 161-1, the input sensor 161-2, and the digitizer 161-3 may be disposed above/on the display panel 141, and any one (e.g., the digitizer 161-3) of the fingerprint sensor 161-1, the input sensor 161-2, and the digitizer 161-3 may be disposed below/under the display panel 141.

At least two of the fingerprint sensor 161-1, the input sensor 161-2, and the digitizer 161-3 may be integrally formed in the form of one sensing panel through the same process. When the at least two of the fingerprint sensor 161-1, the input sensor 161-2, and the digitizer 161-3 are integrally formed in the form of one sensing panel, the sensing panel may be disposed between the display panel 141 and the window may be disposed above/on the display panel 141. According to one embodiment, the sensing panel may be disposed on the window, and the position of the sensing panel is not specifically limited.

At least one of the fingerprint sensor 161-1, the input sensor 161-2, and the digitizer 161-3 may be embedded in the display panel 141. In this regard, at least one of the fingerprint sensor 161-1, the input sensor 161-2, and the digitizer 161-3 may be simultaneously formed through a process for forming components (e.g., a light emitting element and a transistor) included in the display panel 141.

In addition, the sensor module 161 may generate an electrical signal or a data value corresponding to an internal state or an external state of the electronic device DD. The sensor module 161 may further include, for example, a gesture sensor, a gyro sensor, a pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 162 may include at least one antenna to transmit or receive the signal or power to or from an external source. According to an embodiment, through an antenna suitable for a communication scheme, the communication module 173 may transmit a signal to an external electronic device or may receive a signal from the external electronic device. An antenna pattern of the antenna module 162 may be integrated into one component (e.g., the display panel 141) of the display module 140 or the input sensor 161-2.

The sound output module 163 is a device for outputting a sound signal to the outside of the electronic device DD. The sound output module 163 may include, for example, a speaker used for multimedia playback or recording playback and a receiver used exclusively for receiving calls. According to an embodiment, the receiver and the speaker may be either integrally or separately implemented. A sound output pattern of the sound output module 163 may be integrated into the display module 140.

The camera module 171 may photograph a still image and a moving image. According to one embodiment, the camera module 171 may include at least one lens, an image sensor, or an image signal processor. The camera module 171 may further include an infrared camera capable of generating data indicative of the presence or absence of the user, the position of the user, and the line of sight of the user.

The light module 172 may provide a light. The light module 172 may include a light emitting diode or a xenon lamp. The light module 172 may operate in conjunction with the camera module 171 or may operate independently.

The communication module 173 may establish a wired or wireless communication channel between the electronic device DD and the external electronic device DD-A and may support communication execution through the established communication channel. The communication module 173 may include one of a wireless communication module, such as a cellular communication module, a short-range wireless communication module, or a global navigation satellite system (GNSS) communication module, and a wired communication module, such as a local area network (LAN) communication module or a power line communication module or may include all thereof. The communication module 173 may communicate with the external electronic device DD-A over a short-range communication network such as Bluetooth, Wi-Fi direct, or infrared data association (IrDA) or a long-range communication network such as a cellular network, an Internet, or a computer network (e.g., a LAN or a wide area network (WAN)). Various types of communication modules described above may be implemented into one chip or implemented in the form of separate chips.

The input module 130, the sensor module 161, and the camera module 171 may be used to control the operation of the display module 140 while operating with the processor 110.

The processor 110 outputs commands or data to the display module 140, the sound output module 163, the camera module 171, or the light module 172 based on the input data received from the input module 130. For example, the processor 110 may generate the image data corresponding to the input data applied through the mouse or the active pen and may output the image data to the display module 140; alternatively, the processor 110 may generate command data corresponding to the input data and may output the command data to the camera module 171 or the light module 172. When input data are not received from the input module 130 during a specific period of time, the processor 110 may switch an operating mode of the electronic device DD to a low-power mode or a sleep mode such that the power consumption of the electronic device DD is reduced.

The processor 110 outputs commands or data to the display module 140, the sound output module 163, the camera module 171, or the light module 172 based on the sensing data received from the sensor module 161. For example, the processor 110 may compare authentication data, which is obtained through the fingerprint sensor 161-1, with authentication data stored in the memory 120 and may then execute an application depending on a comparison result. The processor 110 may execute a command based on the sensing data sensed by the input sensor 161-2 or the digitizer 161-3 or may output image data corresponding to the sensing data to the display module 140. When the sensor module 161 includes a temperature sensor, the processor 110 may receive temperature data about the temperature from the sensor module 161 and may further correct brightness of the image data based on the temperature data.

The processor 110 may receive data about the presence or absence of the user, the position of the user, and the line of sight of the user from the camera module 171. The processor 110 may further correct the brightness of the image data based on the data. For example, the processor 110 that determines the presence or absence of the user through the input from the camera module 171 may output, to the display module 140, image data having brightness corrected through the data conversion circuit 112-2 or the gamma correction circuit 112-3.

Some of the above components may be connected to each other through a communication scheme between peripheral devices, for example, a bus, a general purpose input/output (GPIO), a serial peripheral interface (SPI), a mobile industry processor interface (MIPI), or a ultra-path interconnect (UPI) link and may exchange signals (e.g., commands or data). The processor 110 may communicate with the display module 140 through a specific interface. For example, one of the communication schemes described above may be used, and embodiments are not limited thereto.

The electronic device DD according to various embodiments may be implemented as various types of devices. The electronic device DD may include, for example, at least one of a portable communication device (e.g., a smartphone), a computer device, a portable multimedia device, a portable medical device, a camera, a wearable device, and home appliances. The electronic device DD according to embodiments is not limited to the above devices.

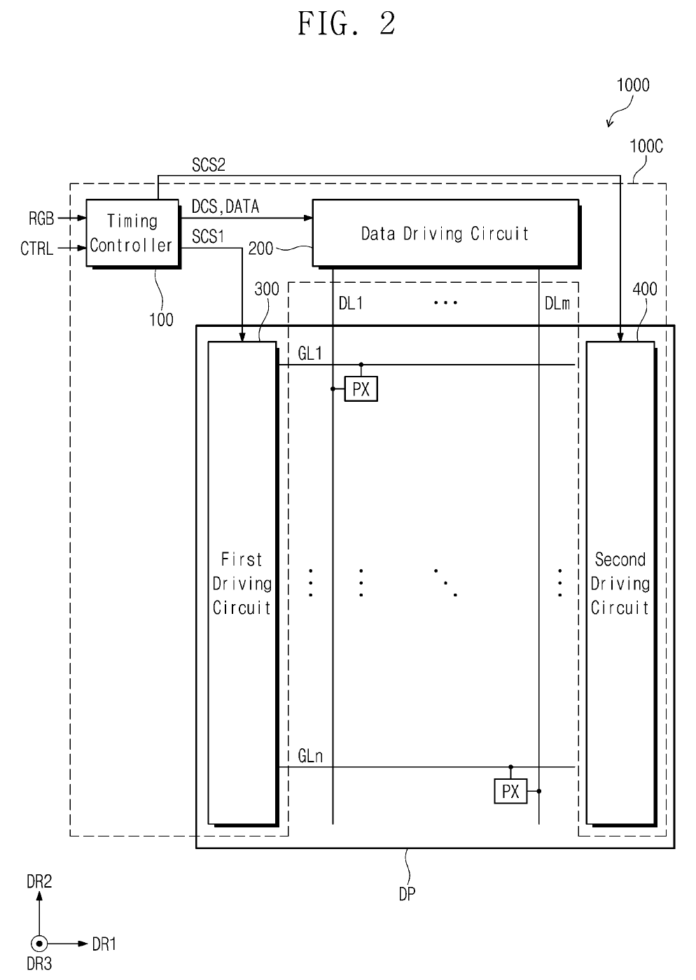

FIG. 2 is a block diagram illustrating a display panel and a display driver according to an embodiment.

Referring to FIG. 2, an electronic device 1000 may include a display panel DP and a display driver 100C. For example, the electronic device 1000 may correspond to the electronic device DD (see FIG. 1).

The display panel DP may have a display surface parallel to a plane defined by a first direction DR1 and a second direction DR2. The display surface may include a display region and a non-display region. The second direction DR2 may cross the first direction DR1. A thickness direction of the display panel DP may be parallel to a third direction DR3 crossing the first direction DR1 and the second direction DR2. The display panel DP may correspond to the display panel 141 (see FIG. 1).

The display panel DP may include a plurality of scan lines GL1 to GLn, a plurality of data lines DL1 to DLm, and a plurality of pixels PX. In this case, ‘n’ and ‘m’ are natural numbers equal to or greater than ‘1’.

Each of the plurality of scan lines GL1 to GLn may extend in the first direction DR1. The plurality of scan lines GL1 to GLn may be spaced apart in the second direction DR2. Each of the plurality of data lines DL1 to DLm may extend in the second direction DR2, and the plurality of data lines DL1 to DLm may be spaced apart in the first direction DR1.

The plurality of pixels PX may be disposed in the display region. The plurality of pixels PX may be arranged in the first direction DR1 and the second direction DR2. Each of the plurality of pixels PX may be electrically connected to a relevant one of the plurality of scan lines GL1 to GLn, and a relevant one of the plurality of data lines DL1 to DLm.

The display driver 100C may include a timing controller 100, a data driving circuit 200, a first driving circuit 300, and a second driving circuit 400.

The timing controller 100 may receive an input signal including an image signal RGB and a control signal CTRL. The timing controller 100 may generate an image data signal DATA by converting a data format of the image signal RGB in conformance with the specification for an interface with the data driving circuit 200. The timing controller 100 may control the data driving circuit 200, the first driving circuit 300, and the second driving circuit 400 such that an image is displayed in the display panel DP. The timing controller 100 may output a first scan control signal SCS1, a second scan control signal SCS2, and a data control signal DCS, depending on an operating mode. The timing controller 100 may include the controller 112-1 (see FIG. 1).

The data driving circuit 200 may receive the data control signal DCS and the image data signal DATA from the timing controller 100. The data driving circuit 200 transforms the data signal DATA into data signals and outputs the data signals to the data lines DL1 to DLm. The data signals may be analog voltages corresponding to grayscale values of the image data signal DATA. The data driving circuit 200 may be implemented in the form of an integrated circuit and directly mounted in a specific region of the display panel DP, or may be mounted, in a chip on film manner, on a separate printed circuit board such that the data driving circuit 200 is electrically connected to the display panel DP, but embodiments are not specifically limited thereto. For example, the data driving circuit 200 may be formed in the same process as a circuit layer in the display panel DP. The data driving circuit 200 may correspond to the data driver 143 in FIG. 1.

The first driving circuit 300 and the second driving circuit 400 may be formed in the same process as that of the circuit layer in the display panel DP and may be included in the display panel DP, but embodiments are not limited thereto. For example, the first driving circuit 300 may be implemented in the form of an integrated circuit (IC) and mounted directly in a specific region of the display panel DP, or mounted in the form of a chip on film (COF) manner on a separate printed circuit board, such that the first driving circuit 300 is electrically connected to the display panel DP.

The first driving circuit 300 and the second driving circuit 400 may be arranged to face each other. The pixels PX may be interposed between the first driving circuit 300 and the second driving circuit 400. However, embodiments are not limited thereto. For example, the electronic device 1000 may include only one of the first driving circuit 300 and the second driving circuit 400. The first driving circuit 300 and the second driving circuit 400 may be included in the scan driver 142 (see FIG. 1) in FIG. 1. The first driving circuit 300 and the second driving circuit 400 may be disposed in the non-display region.

The first driving circuit 300 may receive the first scan control signal SCS1 from the timing controller 100. The first driving circuit 300 may output scan signals to the scan lines GL1 to GLn, in response to the first scan control signal SCS1.

The second driving circuit 400 may receive the second scan control signal SCS2 from the timing controller 100. The second driving circuit 400 may output scan signals to the plurality of the scan lines GL1 to GLn, in response to the second scan control signal SCS2.

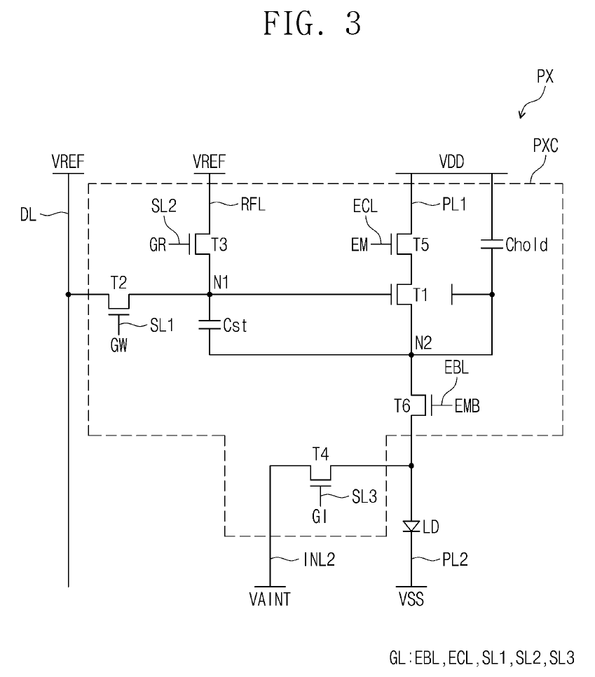

FIG. 3 is a schematic equivalent circuit diagram of a pixel according to an embodiment.

Each of the pixels PX (see FIG. 2) illustrated in FIG. 2 may have the same circuit configuration as the equivalent circuit diagram of the pixel PX illustrated in FIG. 3.

Referring to FIG. 3, the pixel PX may include a light emitting element LD and a pixel circuit PXC to control the light emitting element LD.

The pixel circuit PXC may include at least one transistor and at least one capacitor. The first driving circuit 300 (see FIG. 2) and the second driving circuit 400 (see FIG. 2) may include transistors formed through the same process as the pixel circuit PXC.

The pixel circuit PXC may be connected to a data line DL. The data line DL may be one of the plurality of data lines DL1 to DLm (see FIG. 2) illustrated in FIG. 2. A data voltage Vdata may be applied to the data line DL.

The pixel circuit PXC may be connected to a scan line GL. The scan line GL may be one of the plurality of scan lines GL1 to GLn (see FIG. 2) illustrated in FIG. 2. The scan line GL may include a first scan line SL1, a second scan line SL2, a third scan line SL3, a first emission control line ECL, and a second emission control line EBL.

A first scan signal GW may be applied to the first scan line SL1. A second scan signal GR may be applied to the second scan line SL2. A third scan signal GI may be applied to the third scan line SL3. A first emission control signal EM may be applied to the first emission control line ECL. A second emission control signal EMB may be applied to the second emission control line EBL.

A first power line PL1, a second power line PL2, a reference voltage line RFL, and an initialization power line INL may be connected to the pixel PX. Power supply voltages may be applied to the first power line PL1, the second power line PL2, the reference voltage line RFL, and the initialization power line INL.

A first power supply voltage VDD may be applied to the first power line PL1, and a second power supply voltage VSS may be applied to the second power line PL2. The second power supply voltage VSS may have a voltage level lower than a voltage level of the first power supply voltage VDD.

A reference power supply voltage VREF may be applied to the reference voltage line RFL. The reference power supply voltage VREF may have a voltage level equal to or different from a voltage level of the first power supply voltage VDD.

An initialization power supply voltage VAINT may be applied to the initialization power line INL. For example, the initialization power supply voltage VAINT may have a voltage level lower than the voltage level of the first power supply voltage VDD, and higher than a voltage level of the second power supply voltage VSS.

The pixel circuit PXC may include a first transistor T1, a second transistor T2, a third transistor T3, a fourth transistor T4, a fifth transistor T5, a sixth transistor T6, a seventh transistor T7, a first capacitor Cst, and a second capacitor Chold.

The first to seventh transistors T1 to T7 may be N-type transistors including a semiconductor layer including an oxide semiconductor. However, embodiments are not limited thereto. For example, the fifth transistor T5 and the sixth transistor T6 of the first to seventh transistors T1 to T7 may be P-type transistors having a low-temperature polycrystalline silicon (LTPS) semiconductor layer. In addition, the circuit configuration of the pixel according to embodiments is not limited thereto. The pixel circuit PXC illustrated in FIG. 3 is provided only for illustrative purpose, and the configuration of the pixel circuit PXC may be modified and implemented.

The first transistor T1 may be electrically connected between the first power line PL1 and a second node N2. For example, a first electrode of the first transistor T1 may be connected to the first power line PL1 through the fifth transistor T5. A second electrode of the first transistor T1 may be connected to the second node N2. A gate electrode of the first transistor T1 may be connected to a first node N1. In addition, the first transistor T1 may further include a lower electrode (or a second electrode) corresponding to the gate electrode of the first transistor T1. The lower electrode may be connected to the second node N2. The first transistor T1 may supply a driving current to the light emitting element LD, or may control an amount of the driving current flowing from the first power line PL1 to the light emitting element LD. For example, the first transistor T1 may supply the driving current, which corresponds to a voltage at the first node N1, to the light emitting element LD. The first transistor T1 may be referred to as a driving transistor.

The second transistor T2 may be electrically connected between the data line DL and the first node N1. A gate electrode of the second transistor T2 may be connected to the first scan line SL1. The second transistor T2 may be turned on in response to the first scan signal GW of the first scan line SL1. When the second transistor T2 is turned on, the data voltage Vdata of the data line DL may be transferred to the first node N1. The second transistor T2 may be referred to as a switch transistor T2.

The third transistor T3 may be electrically connected between the reference power line RFL and the first node N1. A gate electrode of the third transistor T3 may be connected to the second scan line SL2. The third transistor T3 may be turned on in response to the second scan signal GR of the second scan line SL2. When the third transistor T3 is turned on, the reference power supply voltage VREF may be transferred to the first node N1.

The fourth transistor T4 may be electrically connected between an anode electrode of the light emitting element LD and the initialization power line INL2. A gate electrode of the fourth transistor T4 may be connected to the third scan line SL3. The fourth transistor T4 may be turned on in response to the third scan signal GI of the third scan line SL3. When the fourth transistor T4 is turned on, the initialization power supply voltage VAINT may be transferred to the anode electrode of the light emitting element LD.

The fifth transistor T5 may be electrically connected between the first power line PL1 and the first transistor T1. A gate electrode of the fifth transistor T5 may be connected to the first emission control line ECL. The fifth transistor T5 may be turned on in response to the first emission control signal EM of the first emission control line ECL.

The sixth transistor T6 may be electrically connected between the second node N2 and the anode electrode of the light emitting element LD. A gate electrode of the sixth transistor T6 may be connected to the second emission control line EBL. The sixth transistor T6 may be turned on in response to the second emission control signal EMB of the second emission control line EBL.

The first capacitor Cst may be formed between the first node N1 and the second node N2, or may be electrically connected to the first node N1 and the second node N2. The first capacitor Cst may store a voltage corresponding to the data voltage Vdata. The first capacitor Cst may be referred to as a storage capacitor.

The second capacitor Chold may be formed between the first power line PL1 and the second node N2, or may be electrically connected to the first power line PL1 and the second node N2. The second capacitor Chold may stabilize the voltage at the second node N2. The second capacitor Chold may be referred to as a hold capacitor.

The light emitting element LD may be electrically connected between the sixth transistor T6 and the second power line PL2. The light emitting element LD may emit light having a brightness corresponding to the driving current, when the driving current is supplied to the light emitting element LD by the first transistor T1.

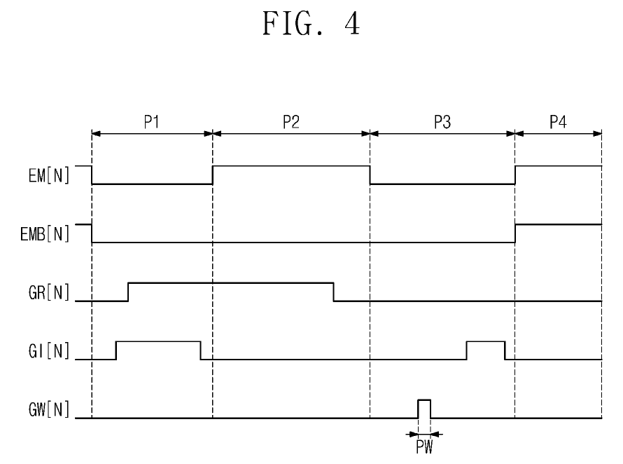

FIG. 4 is a waveform diagram to describe the operation of a pixel according to an embodiment.

Referring to FIGS. 3 and 4, one frame may be defined as a frame duration in which one frame image is displayed. One frame may include a first period P1, a second period P2, a third period P3, and a fourth period P which are sequentially defined.

When the pixel PX is included in an N-th pixel row, a first emission control signal EM[N], a second emission control signal EMB[N], a first scan signal GW[N], a second scan signal GR[N], and a third scan signal GI[N] may be applied to the pixel PX. In this case, ‘N’ is a positive integer, and “[N]” may refer to “N-th”. For example, “EM[N]” may refer to a first emission control signal provided to the pixel PX in the N-th pixel row.

The first emission control signal EM[N] may have a turn-off voltage level (or a gate-off voltage level or a low level) for the first period P1 and the third period P3, and may have a turn-on voltage level (or a gate-on voltage level or a high level) for the second period P2 and the fourth period P4. The second emission control signal EMB[N] may have the turn-off voltage level for the first period P1, the second period P2, and the third period P3, and may have the turn-on voltage level for the fourth period P4. The first period P1, the second period P2, the third period P3, and the fourth period P4 may be divided based on the first emission control signal EM[N] and the second emission control signal EMB[N].

The fifth transistor T5 may be turned off in response to the first emission control signal EM[N] having the turn-off voltage level, and the sixth transistor T6 may be turned off in response to the second emission control signal EMB[N] having the turn-off voltage level, for the first period P1. A current path of the light emitting element LD may be blocked. The light emitting element LD may not emit light.

For the first period P1, the second scan signal GR[N] may have the turn-on voltage level. The third transistor T3 may be turned on in response to the second scan signal GR[N] having the turn-on voltage level. The first node N1 may be initialized by the reference power supply voltage VRFE.

For the first period P1, the third scan signal GI[N] may have the turn-on voltage level. The fourth transistor T4 may be turned on in response to the third scan signal GI[N] having the turn-on voltage level. The anode electrode of the light emitting element LD may be initialized by the initialization power supply voltage VAINT.

The pixel PX may be initialized for the first period P1. The first period P1 may be referred to as an initialization period.

The first scan signal GW[N] may have the turn-off voltage level for the first period P1 and the second period P2.

For the second period P2, the second scan signal GR[N] may have the turn-on voltage level. When the reference power supply voltage VREF is set to be higher than a voltage corresponding to the sum of the voltage at the second node N2 and the threshold voltage at the first transistor T1, the first transistor T1 may be turned on.

For the second period P2, the third scan signal GI[N] may have the turn-off voltage level. The fourth transistor T4 may be turned off in response to the third scan signal GI[N] having the turn-off voltage level.

For the second period P2, the first emission control signal EM[N] may have the turn-on voltage level. The fifth transistor T5 may be turned on in response to the first emission control signal EM[N] having the turn-on voltage level. The voltage at the second node N2 may be changed by the driving current flowing through the first transistor T1. The voltage at the second node N2 may be changed to a value obtained by subtracting the threshold voltage at the first transistor T1 from the voltage at the first node N1. A voltage corresponding to the threshold voltage at the first transistor T1 may be stored in the first capacitor Cst.

The threshold voltage at the first transistor T1 may be compensated for the second period P2. The second period P2 may be referred to as a compensating period.

For the third period P3, the second scan signal GR[N] may have the turn-off voltage level.

For the third period P3, the first scan signal GW[N] may have the turn-on voltage level. The second transistor T2 may be turned on in response to the first scan signal GW[N] having the turn-on voltage level. The data voltage Vdata may be transferred to the first node N1. The data voltage Vdata may be written in the first capacitor Cst.

For the third period P3, after the first scan signal GW[N] is shifted to have the turn-off voltage level, the third scan signal GI[N] may have the turn-on voltage level. The anode electrode of the light emitting element LD may be initialized again by the initialization power supply voltage VAINT, or a capacitor component of the light emitting element LD may be charged with the initialization power supply voltage VAINT. The pixel PX may be in a ready state to emit light.

For the third period P3, the first scan signal GW[N] having the turn-on voltage level may have a specific pulse width PW. The pulse width PW may be longer than one horizontal period (1H). For example, the pulse width PW may be two horizontal periods (2H). However, this provided only for the illustrative purpose. The pulse width PW according to embodiments is not limited thereto.

The data voltage Vdata may be written in the pixel PX for the third period P3. The third period P3 may be referred to as a data writing period.

For the fourth period P4, each of the first scan signal GW[N], the second scan signal GR[N], and the third scan signal GI[N] may have the turn-off voltage level.

For the fourth period P4, each of the first emission control signal EM[N] and the second emission control signal EMB[N] may have the turn-on voltage level. The fifth transistor T5 and the sixth transistor T6 may be turned on in response to the first emission control signal EM[N] and the second emission control signal EMB[N] having the turn-on voltage level. A current path may be formed between the first power line PL1 and the second node N2. The first transistor T1 may supply the driving current, which corresponds to a voltage stored in the first capacitor Cst, to the light emitting element LD. The light emitting element LD may emit a light having brightness corresponding to the driving current.

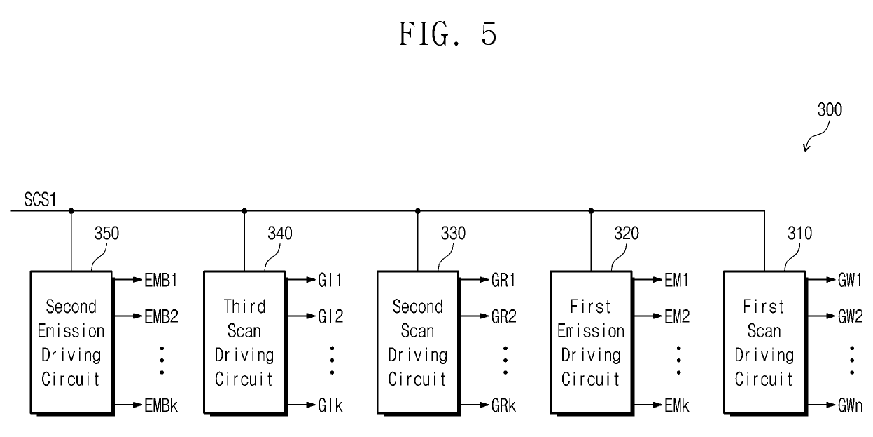

FIG. 5 is a block diagram illustrating a first driving circuit according to an embodiment.

Referring to FIGS. 3 and 5, the first driving circuit 300 may include a first scan driving circuit 310, a first emission driving circuit 320, a second scan driving circuit 330, a third scan driving circuit 340, and a second emission driving circuit 350.

The first scan driving circuit 310 may output first scan signals GW1 to GWn to be provided to the first scan line SL1 relevant, in response to the first scan control signal SCS1.

The first emission driving circuit 320 may output first emission control signals EM1 to EMk to be provided to the first emission control line ECL relevant, in response to the first scan control signal SCS1. According to an embodiment, n>k may be satisfied. The first emission control signals EM1 to EMk may be provided to at least two first emission control lines.

The second scan driving circuit 330 may output second scan signals GR1 to GRk to be provided to the second scan line SL2 relevant, in response to the first scan control signal SCS1. The second scan signals GR1 to GRk may be provided to at least two second scan lines.

The third scan driving circuit 340 may output third scan signals GI1 to GIk to be provided to the third scan line SL3 relevant, in response to the first scan control signal SCS1. The third scan signals GI1 to GIk may be provided to at least two third scan lines.

The second emission driving circuit 350 may output the second emission control signals EMB1 to EMBk to be provided to the second emission control line EBL relevant, in response to the first scan control signal SCS1. The second emission control signals EMB1 to EMBk may be provided to at least two second emission control lines.

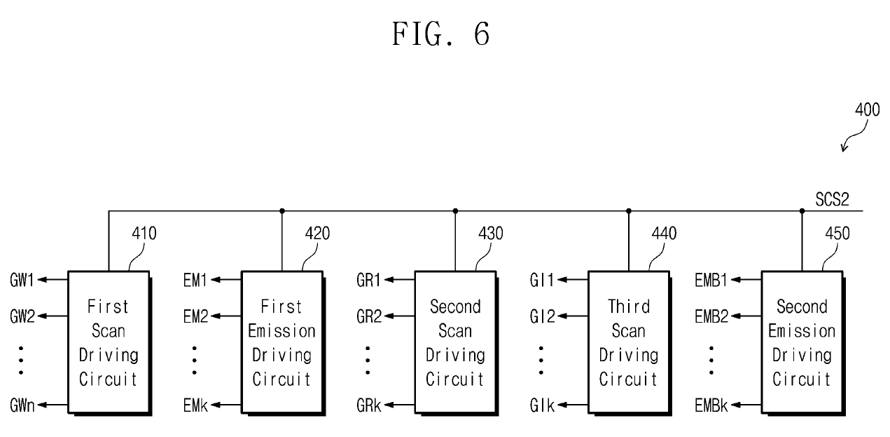

FIG. 6 is a block diagram illustrating a second driving circuit according to an embodiment.

Referring to FIGS. 3 and 6, the second driving circuit 400 may include a first scan driving circuit 410, a first emission driving circuit 420, a second scan driving circuit 430, a third scan driving circuit 440, and a second emission driving circuit 450.

The first scan driving circuit 410 may output the first scan signals GW1 to GWn to be provided to the first scan line SL1 relevant, in response to the second scan control signal SCS2.

The first emission driving circuit 420 may output the first emission control signals EM1 to EMk to be provided to the first emission control line ECL relevant, in response to the second scan control signal SCS2. According to an embodiment, n>k may be satisfied. The first emission control signals EM1 to EMk may be provided to at least two first emission control lines.

The second scan driving circuit 430 may output the second scan signals GR1 to GIk to be provided to the second scan line SL2 relevant, in response to the second scan control signal SCS2. The second scan signals GR1 to GRk may be provided to at least two second scan lines.

The third scan driving circuit 440 may output the third scan signals GI1 to GIk to be provided to the third scan line SL3 relevant, in response to the second scan control signal SCS2. The third scan signals GI1 to GIk may be provided to at least two third scan lines.

The second emission driving circuit 450 may output the second emission control signals EMB1 to EMBk to be provided to the second emission control line EBL relevant, in response to the second scan control signal SCS2. The second emission control signals EMB1 to EMBk may be provided to at least two second emission control lines.

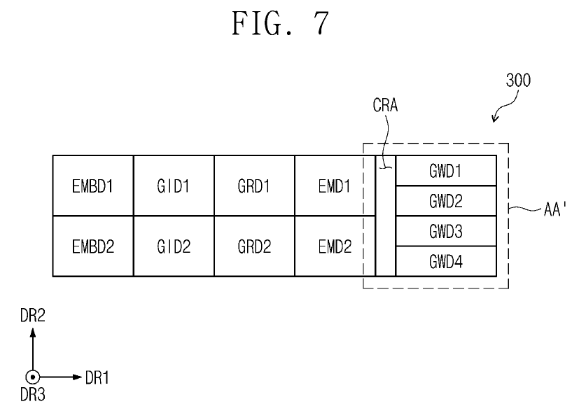

FIG. 7 is a schematic block diagram illustrating a first driving circuit according to an embodiment.

Referring to FIGS. 5 and 7, the first scan driving circuit 310 may include a plurality of first scan stages GWD1, GWD2, GWD3, and GWD4.

The plurality of first scan stages GWD1, GWD2, GWD3, and GWD4 may be connected to the scan lines GL1 to GLn (see FIG. 2), respectively. Each of the plurality of first scan stages GWD1, GWD2, GWD3, and GWD4 may be connected to the first scan line SL1 (see FIG. 3) relevant.

The plurality of first scan stages GWD1, GWD2, GWD3, and GWD4 may be arranged in the second direction DR2.

The plurality of first scan stages GWD1, GWD2, GWD3, and GWD4 may include a (1-1)-th scan stage GWD1, a (1-2)-th scan stage GWD2, a (1-3)-th scan stage GWD3, and a (1-4)-th scan stage GWD4.

The (1-1)-th scan stage GWD1 may drive the plurality of pixels PX disposed in a first pixel row. The (1-1)-th scan stage GWD1 may output a (1-1)-th scan signal GW1.

The (1-2)-th scan stage GWD2 may drive the plurality of pixels PX disposed in a second pixel row. The (1-2)-th scan stage GWD2 may output a (1-2)-th scan signal GW2.

The (1-3)-th scan stage GWD3 may drive the plurality of pixels PX disposed in a third pixel row.

The (1-4)-th scan stage GWD4 may drive the plurality of pixels PX disposed in a fourth pixel row.

The first emission driving circuit 320 may include a plurality of first emission stages EMD1 and EMD2.

The plurality of first emission stages EMD1 and EMD2 may be connected to the scan lines GL1 to GLn (see FIG. 2), respectively. Each of the plurality of first emission stages EMD1, and EMD2 may be connected to the first emission control line ECL (see FIG. 3) relevant.

The plurality of first emission stages EMD1 and EMD2 may be arranged in the second direction DR2. The plurality of first emission stages EMD1 and EMD2 may be spaced apart from the plurality of first scan stages GWD1, GWD2, GWD3, and GWD4 in the first direction DR1.

The plurality of first emission stages EMD1 and EMD2 may include a (1-1)-th emission stage EMD1 and a (1-2)-th emission stage EMD2.

The (1-1)-th emission stage EMD1 may drive the plurality of pixels PX disposed in the first pixel row and the second pixel row. The (1-1)-th emission stage EMD1 may output the (1-1)-th emission control signal EM1.

The (1-2)-th emission stage EMD2 may drive the plurality of pixels PX disposed in a third pixel row and in a fourth pixel row. The (1-2)-th emission stage EMD2 may output the (1-2)-th emission control signal EM2.

An interconnection region CRA may be defined between the plurality of first scan stages GWD1, GWD2, GWD3, and GWD4 and the plurality of first emission stages EMD1 and EMD2. The interconnection region CRA may extend in the second direction DR2. At least some of a plurality of clock lines may be disposed in the interconnection region CRA.

The second scan driving circuit 330 may include the plurality of second scan stages GRD1 and GRD2.

The plurality of second scan stages GRD1 and GRD2 may be connected to the scan lines GL1 to GLn (see FIG. 2), respectively. Each of the plurality of second scan stages GRD1 and GRD2 may be connected to the second scan line SL2 (see FIG. 3) relevant.

The plurality of second scan stages GRD1 and GRD2 may be arranged in the second direction DR2. The plurality of second scan stages GRD1 and GRD2 may be spaced apart from the plurality of first emission stages EMD1 and EMD2 in the first direction DR1.

The plurality of second scan stages GRD1 and GRD2 may include a (2-1)-th scan stage GRD1 and a (2-2)-th scan stage GRD2.

The (2-1)-th scan stage GRD1 may drive the plurality of pixels PX disposed in the first pixel row and the second pixel row. The (2-1)-th scan stage GRD1 may output the (2-1)-th scan signal GR1.

The (2-2)-th scan stage GRD2 may drive the plurality of pixels PX disposed in the third pixel row and the fourth pixel row. The (2-2)-th scan stage GRD2 may output the (2-2)-th scan signal GR2.

The third scan driving circuit 340 may include a plurality of third scan stages GID1 and GID2.

The plurality of third scan stages GID1 and GID2 may be connected to the scan lines GL1 to GLn (see FIG. 2), respectively. Each of the plurality of third scan stages GID1 and GID2 may be connected to the third scan line SL3 (see FIG. 3) relevant.

The plurality of third scan stages GID1 and GID2 may be arranged in the second direction DR2. The plurality of third scan stages GID1 and GID2 may be spaced apart from the plurality of second scan stages GRD1 and GRD2 in the first direction DR1.

The plurality of third scan stages GID1 and GID2 may include a (3-1)-th scan stage GID1 and a (3-2)-th scan stage GID2.

The (3-1)-th scan stage GID1 may drive the plurality of pixels PX disposed in the first pixel row and the second pixel row. The (3-1)-th scan stage GID1 may output the (3-1)-th scan signal GI1.

The (3-2)-th scan stage GID2 may drive the plurality of pixels PX disposed in the third pixel row and the fourth pixel row. The (3-2)-th scan stage GID2 may output the (3-2)-th scan signal GI2.

The second emission driving circuit 350 may include a plurality of second emission stages EMBD1 and EMBD2.

The plurality of second emission stages EMBD1 and EMBD2 may be connected to the scan lines GL1 to GLn (see FIG. 2), respectively. Each of the plurality of second emission stages EMBD, and EMBD2 may be connected to the second emission control line EBL (see FIG. 3) relevant.

The plurality of second emission stages EMBD1 and EMBD2 may be arranged in the second direction DR2. The plurality of second emission stages EMBD1 and EMBD2 may be spaced apart from the plurality of third scan stages GID1 and GID2 in the first direction DR1.

The plurality of second emission stages EMBD1 and EMBD2 may include a (2-1)-th emission stage EMBD1 and a (2-2)-th emission stage EMBD2.

The (2-1)-th emission stage EMBD1 may drive the plurality of pixels PX disposed in the first pixel row and the second pixel row. The (2-1)-th emission stage EMBD1 may output the (2-1)-th emission control signal EMB1.

The (2-2)-th emission stage EMBD2 may drive the plurality of pixels PX disposed in the third pixel row and the fourth pixel row. The (2-2)-th emission stage EMBD2 may output the (2-2)-th emission control signal EMB2.

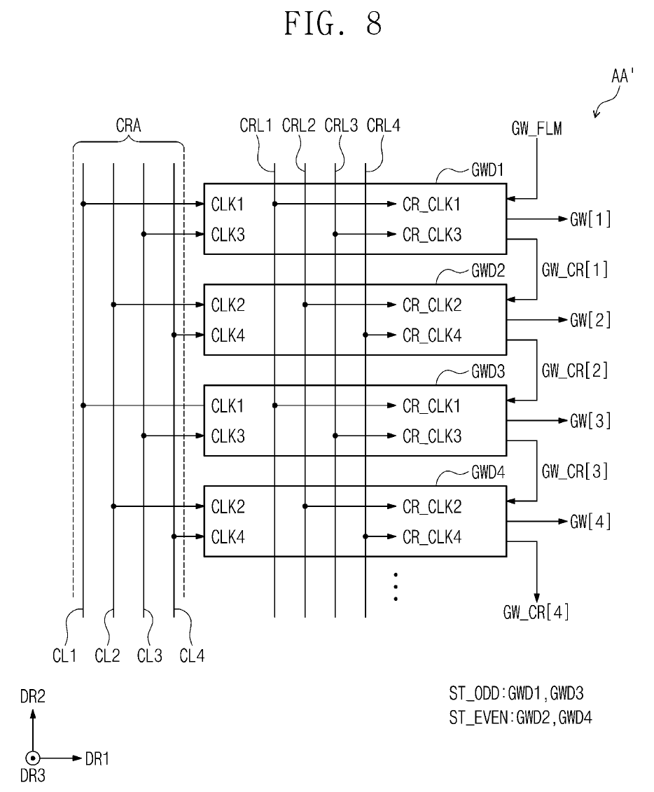

FIG. 8 is a schematic block diagram illustrating expanded region AA’ of a first driving circuit in FIG. 7 according to an embodiment.

Referring to FIG. 8, the plurality of first scan stages GWD1, GWD2, GWD3, and GWD4 may output the plurality of first scan signals GW[1], GW[2], GW[3], and GW[4], respectively. Each of the plurality of first scan stages GWD1, GWD2, GWD3, and GWD4 may include at least one scan transistor and a capacitor. The plurality of first scan stages GWD1, GWD2, GWD3, and GWD4 may actually have the same internal configurations.

The display panel DP (see FIG. 2) may further include a plurality of clock lines CL1 to CL4, and CRL1 to CRL4. The plurality of first scan stages GWD1, GWD2, GWD3, and GWD4 may be electrically connected to the plurality of clock lines CL1 to CL4, and CRL1 to CRL4.

The plurality of clock lines CL1 to CL4, and CRL1 to CRL4 may include the plurality of scan clock lines CL1 to CL4, and the plurality of logic clock lines CRL1 to CRL4.

The plurality of scan clock lines CL1 to CL4 may be adjacent to the plurality of first scan stages GWD1 to GWD4 in the first direction DR1. The plurality of scan clock lines CL1 to CL4 may be spaced apart from each other in the first direction DR1. Each of the plurality of scan clock lines CL1 to CL4 may extend in the second direction DR2.

The plurality of scan clock lines CL1 to CL4 may be disposed in the interconnection region CRA.

The plurality of scan clock lines CL1 to CL4 may include the first scan clock line CL1 for applying a first clock signal CLK1, the second scan clock line CL2 for applying a second clock signal CLK2, the third scan clock line CL3 for applying a third clock signal CLK3, and the fourth scan clock line CL4 for applying a fourth clock signal CLK4.

Each of the plurality of first scan stages GWD1, GWD2, GWD3, and GWD4 may be electrically connected to the first and third scan clock lines CL1 and CL3, or the second and fourth scan clock lines CL2 and CL4.

The plurality of logic clock lines CRL1 to CRL4 may be adjacent to the plurality of scan clock lines CL1 to CL4 in the first direction DR1. The plurality of logic clock lines CRL1 to CRL4 may be spaced apart from each other in the first direction DR1. Each of the plurality of logic clock lines CRL1 to CRL4 may extend in the second direction DR2.

The plurality of logic clock lines CRL1 to CRL4 may include the first logic clock line CRL1 for applying a first logic clock signal CR_CLK1, the second logic clock line CRL2 for applying a second logic clock signal CR_CLK2, the third logic clock line CRL3 for applying a third logic clock signal CR_CLK3, and the fourth logic clock line CRL4 for applying a fourth logic clock signal CR_CLK4.

Each of the plurality of first scan stages GWD1, GWD2, GWD3, and GWD4 may be electrically connected to the first and third logic clock lines CR_CLK1 and CR_CLK3, or the second and fourth scan logic lines CR_CLK2 and CR_CLK4.

The (1-1)-th scan stage GWD1 may be electrically connected to the first and third scan clock lines CL1 and CL3, or the first and third logic clock lines CRL1 and CRL3. The (1-1)-th scan stage GWD1 may receive the first and third clock signals CLK1 and CLK3, or the first and third logic clock signals CR_CLK1 and CR_CLK3.

The (1-2)-th scan stage GWD2 may be electrically connected to the second and fourth scan clock lines CL2 and CL4, or the second and fourth logic clock lines CRL2 and CRL4. The (1-2)-th scan stage GWD2 may receive the second and fourth clock signals CLK2 and CLK4, or the second and fourth logic clock signals CR_CLK2 and CR_CLK4.

The (1-3)-th scan stage GWD3 may be electrically connected to the first and third scan clock lines CL1 and CL3, or the first and third logic clock lines CRL1 and CRL3. The (1-3)-th scan stage GWD3 may receive the first and third clock signals CLK1 and CLK3, or the first and third logic clock signals CR_CLK1 and CR_CLK3.

The (1-4)-th scan stage GWD4 may be electrically connected to the second and fourth scan clock lines CL2 and CL4, or the second and fourth logic clock lines CRL2 and CRL4. The (1-4)-th scan stage GWD4 may receive the second and fourth clock signals CLK2 and CLK4, or the second and fourth logic clock signals CR_CLK2 and CR_CLK4.

For example, odd-numbered first scan stages ST_ODD may receive the first and third clock signals CLK1 and CLK3, and the first and third logic clock signals CR_CLK1 and CR_CLK3, and even-numbered first scan stages ST_EVEN may receive the second and fourth clock signals CLK2 and CLK4, and the second and fourth logic clock signals CR_CLK2 and CR_CLK4.

Each of the plurality of first scan stages GWD1, GWD2, GWD3, and GWD4 may output, as the first scan signal, a relevant clock signal of the plurality of clock signals CLK1 to CLK4, in response a first scan start signal GW_FLM, or a carry signal from a previous first scan stage, and may output, as a carry signal to be provided to a next first scan stage, a relevant logic clock signal of the plurality of logic clock signals CR_CLK1 to CR_CLK4.

The (1-1)-th scan stage GWD1 may output the third clock signal CLK3 as a (1-1)-th scan signal GW[1] and output the third logic clock signal CR_CLK3 as a first carry signal GW_CR[1], in response to the first scan start signal GW_FLM.

The (1-2)-th scan stage GWD2 may output the fourth clock signal CLK4 as a (1-2)-th scan signal GW[2] and output the fourth logic clock signal CR_CLK4 as a second carry signal GW_CR[2], in response to the first carry signal GW_CR[1].

The (1-3)-th scan stage GWD3 may output the first clock signal CLK1 as a (1-3)-th scan signal GW[3] and output the first logic clock signal CR_CLK1 as a third carry signal GW_CR[3], in response to the second carry signal GW_CR[2].

The (1-4)-th scan stage GWD4 may output the second clock signal CLK2 as a (1-4)-th scan signal GW[4] and output the second logic clock signal CR_CLK2 as a fourth carry signal GW_CR[4], in response to the third carry signal GW_CR[3].

The first scan driving circuit 310 (see FIG. 5) may sequentially output the first scan signals GW[1] to GW[4].

The plurality of scan clock lines CL1 to CL4 may be disposed in the interconnection region CRA and, in a plan view, may be not overlap with (i.e., may be offset from) the plurality of first scan stages GWD1 to GWD4.

The plurality of logic clock lines CRL1 to CRL4 may overlap with the plurality of first scan stages GWD1 to GWD4, in a plan view. The plurality of logic clock lines CRL1 to CRL4 may be disposed on the plurality of first scan stages GWD1 to GWD4.

According to embodiments, as the plurality of logic clock lines CRL1 to CLR4 are disposed to overlap with the plurality of first scan stages GWD1 to GWD4, in a plan view, the area of the interconnection region CRA may be reduced. The reduced area of the interconnection region CRA may allow for the area of the non-display region of the display panel DP (see FIG. 2) to also be reduced. Accordingly, the electronic device 1000 (see FIG. 2) having the non-display region reduced in area may be provided.

According to embodiments, the plurality of scan clock lines CL1 to CL4 may be disposed to be adjacent to the plurality of first scan stages GWD1 to GWD4. The plurality of scan clock lines CL1 to CL4 may have a load less than a load of the plurality of logic clock lines CRL1 to CRL4 overlapped (i.e., in a plan view) with the plurality of first scan stages GWD1, GWD2, GWD3, and GWD4. The first scan signals GW[1] to GW[4] may be output using the plurality of clock signals CLK1 to CLK4 provided to the plurality of scan clock lines CL1 to CL4, respectively. The delay in the outputs of the first scan signals GW[1] to GW[4] may be improved using the arrangement relation between the plurality of scan clock lines CL1 to CL4 and the plurality of logic clock lines CRL1 to CRL4. Accordingly, a charging rate of the data voltage Vdata (see FIG. 3) may be ensured. Accordingly, the electronic device 1000 (see FIG. 2) may be provided with reliability improved in the output of the first scan signals GW[1] to GW[4].

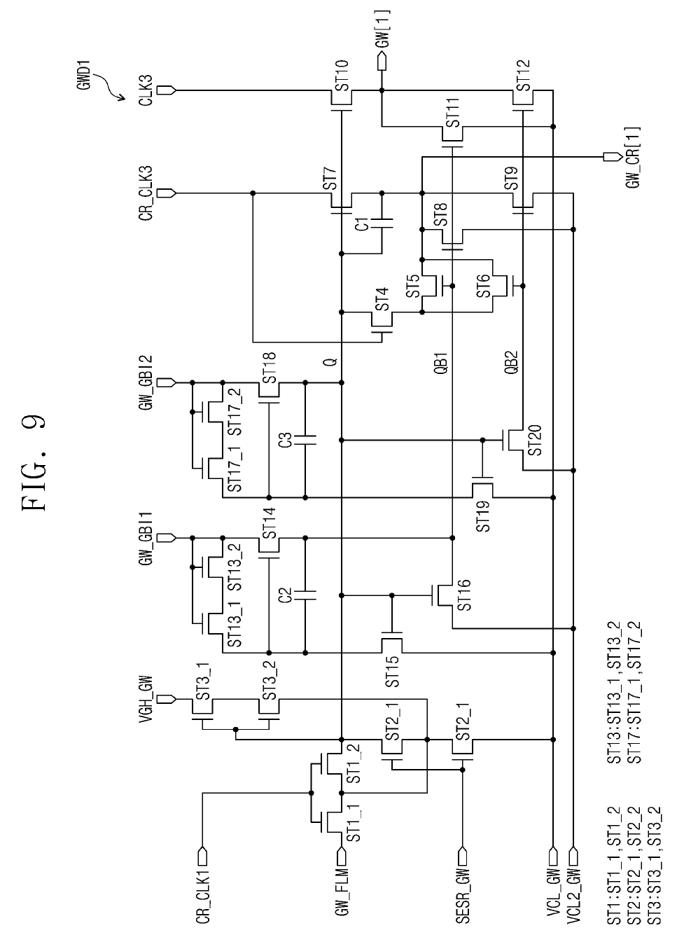

FIG. 9 is a schematic equivalent circuit diagram illustrating a first scan stage according to an embodiment.

Referring to FIGS. 8 and 9, the (1-1)-th scan stage GWD1 may include a plurality of scan transistors and capacitors.

A first scan transistor ST1 of the plurality of scan transistors may be electrically connected between an input terminal for applying the first scan start signal GW_FLM and a first control node Q. A gate electrode of the first scan transistor ST1 may be connected to an input terminal for applying the first logic clock signal CR_CLK1. The first scan transistor ST1 may be turned on, in response to the first logic clock signal CR_CLK1 having the turn-on voltage level, to transmit the first scan start signal GW_FLM to the first control node Q.

The first scan transistor ST1 may include a first sub-transistor ST1_1 and a second sub-transistor ST1_2 which are connected to each other in series between the input terminal for applying the first scan start signal GW_FLM and the first control node Q.

A second scan transistor ST2 of the plurality of scan transistors may be electrically connected between an input terminal for applying a first low power supply voltage VCL_GW and the first control node Q. The first low power supply voltage VCL_GW may have the turn-off voltage level. A gate electrode of the second scan transistor ST2 may be connected to an input terminal for applying a control signal SESR_GW. The second scan transistor ST2 may be turned on, in response to the control signal SESR_GW having the turn-on voltage level, to transmit the first low power supply voltage VCL_GW to the first control node Q.

The second scan transistor ST2 may include a third sub-transistor ST2_1 and a fourth sub-transistor ST2_2 which are connected to each other in series between the input terminal for applying the first low power supply voltage VCL_GW and the first control node Q. The first sub-transistor ST1_1 and the second sub-transistor ST1_2 may be connected to an intermediate node in which the third sub-transistor ST2_1 and the fourth sub-transistor ST2_2 are connected to each other.

A third scan transistor ST3 of the plurality of scan transistors may be electrically connected between an input terminal for applying a high power supply voltage VGH_GW and the intermediate node in which the third sub-transistor ST2_1 and the fourth sub-transistor ST2_2 are connected to each other. The high power supply voltage VGH_GW may have the turn-on voltage level. A gate electrode of the third scan transistor ST3 may be connected to the first control node Q. When the voltage at the first control node Q has the turn-on voltage level, the third scan transistor ST3 may be turned on to transmit the high power supply voltage VGH_GW to the intermediate node. Stress may be reduced between a source and a drain of the first and second scan transistors ST1 and ST2 depending on the operation of the third scan transistor ST3, and the first and second scan transistors ST1 and ST2 may more stably operate.

The third scan transistor ST3 may include a fifth sub-transistor ST3_1 and a sixth sub-transistor ST3_2 which are connected to each other in series between the input terminal for applying the high low power supply voltage VGH_GW and the intermediate node.

A fourth scan transistor ST4 and a fifth scan transistor ST5 of the plurality of scan transistors may be electrically connected to each other between the first control node Q and a carry output terminal for outputting the first carry signal GW_CR[1]. A gate electrode of the fourth scan transistor ST4 may be connected to an input terminal for applying the third logic clock signal CR_CLK3. A gate electrode of the fifth scan transistor ST5 may be connected to a second control node QB1.

A sixth scan transistor ST6 of the plurality of scan transistors may be connected in parallel to the fifth scan transistor ST5. A gate electrode of the sixth scan transistor ST6 may be connected to a third control node QB2.

The fourth scan transistor ST4 is turned on in response to the third logic clock signal CR_CLK3 having the turn-on voltage level, the fifth scan transistor ST5 is turned on when the second control node QB1 has the turn-on voltage level, and the sixth scan transistor ST6 is turned on when the third control node QB2 has the turn-on voltage level, and the first control node Q may be maintained to have the first carry signal GW_CR[1].

A seventh scan transistor ST7 of the plurality of scan transistors may be electrically connected between the input terminal for applying the third carry clock signal CR_CLK3 and the carry output terminal. When the first control node Q has the turn-on voltage level, the seventh scan transistor ST7 may be turned on, and may output the third logic clock signal CR_CLK3 as the first carry signal GW_CR[1].

A first capacitor C1 of the capacitors may be electrically connected between the first control node Q and the carry output terminal. When the first carry signal GW_CR[1] having the turn-on voltage level is output, the first capacitor C1 may boost the voltage at the first control node Q.

An eighth scan transistor ST8 of the plurality of scan transistors may be electrically connected between an terminal for applying a second low power supply voltage VCL2_GW and the carry output terminal. The second low power supply voltage VCL2_GW may have the turn-off voltage level or a voltage level corresponding to the turn-off voltage level. A voltage level of the second low power supply voltage VCL2_GW may be equal to or lower than a voltage level of the first low power supply voltage VCL_GW. However, the voltage level of the second low power supply voltage VCL2_GW according to embodiments is not limited thereto. A gate electrode of the eighth scan transistor ST8 may be electrically connected to the second control node QB1. When the second control node QB2 has the turn-on voltage level, the eighth scan transistor ST8 may be turned on, and the first carry signal GW_CR[1] may be pulled down to the second low power supply voltage VCL2_GW.

A ninth scan transistor ST9 of the plurality of scan transistors may be connected in parallel to the eighth scan transistor ST8. The ninth scan transistor ST9 may be electrically connected between the input terminal for applying the second low power supply voltage VCL2_GW and the carry output terminal. A gate electrode of the ninth scan transistor ST9 may be electrically connected to the third control node QB2. When the third control node QB2 has the turn-on voltage level, the ninth scan transistor ST9 may be turned on, and the first carry signal GW_CR[1] may be pulled down to the second low power supply voltage VCL2_GW.

A tenth scan transistor ST10 of the plurality of scan transistors may be connected between an input terminal for applying the third clock signal CLK3 and a scan output terminal for outputting the first scan signal GW[1]. A gate electrode of the tenth scan transistor ST10 may be connected to the first control node Q. When the first control node Q has the turn-on voltage level, the tenth scan transistor ST10 may be turned on, and may output the third clock signal CLK3 as the first carry signal GW_CR[1].

An eleventh scan transistor ST11 of the plurality of scan transistors may be electrically connected between the input terminal for applying a first low power supply voltage VCL_GW and the scan output terminal. A gate electrode of the eleventh scan transistor ST11 may be electrically connected to the second control node QB1. When the second control node QB1 has the turn-on voltage level, the eleventh scan transistor ST11 may be turned on, and the first scan signal GW[1] may be pulled down to the first low power supply voltage VCL_GW.

A twelfth scan transistor ST12 of the plurality of scan transistors may be connected in parallel to the eleventh scan transistor ST11. The twelfth scan transistor ST12 may be electrically connected between the input terminal for applying the first low power supply voltage VCL_GW and the scan output terminal. A gate electrode of the twelfth scan transistor ST12 may be electrically connected to the third control node QB2. When the third control node QB2 has the turn-on voltage level, the twelfth scan transistor ST12 may be turned on, and the first scan signal GW[1] may be pulled down to the first low power supply voltage VCL_GW.

A thirteenth scan transistor ST13 of the plurality of scan transistors may be electrically connected between an input terminal for applying a first switching signal GW_GBI1 and a gate electrode of the fourteenth scan transistor ST14. A gate electrode of the thirteenth scan transistor ST13 may be connected to the input terminal for applying the first switching signal GW_GBI1. The thirteenth scan transistor ST13 may be turned on in response to the first switching signal GW_GBI1 having the turn-on voltage level, and the first switching signal GW_GBI1 having the turn-on voltage level may be transmitted to the gate electrode of the fourteenth scan transistor ST14.

The thirteenth scan transistor ST13 may include a seventh sub-transistor ST13_1 and an eighth sub-transistor ST13_2 which are connected to each other in series between the input terminal for applying the first switching signal GW_GBI1 and the gate electrode of the fourteenth scan transistor ST14.

A fourteenth scan transistor ST14 of the plurality of scan transistors may be electrically connected between the input terminal for applying the first switching signal GW_GBI1 and the second control node QB1. The fourteenth scan transistor ST14 may be turned on, in response to the first switching signal GW_GBI1 having the turn-on voltage level, to transmit the first switching signal GW_GBI1 having the turn-on voltage level to the second control node QB1.

A second capacitor C2 of the capacitors may be electrically connected between the gate electrode of the fourteenth scan transistor ST14 and the second control node QB1. The function of the second capacitor C2 may be similar to the function of the first capacitor C1.

A fifteenth capacitor ST15 of the plurality of scan transistors may be electrically connected between the gate electrode of the fourteenth scan transistor ST14 and the input terminal for applying the first low power supply voltage VCL_GW. A gate electrode of the fifteenth scan transistor ST15 may be connected to the first control node Q. When the first control node Q has the turn-on voltage level, the fifteenth scan transistor ST15 may be turned on, to transmit the first low power supply voltage VCL_GW to the gate electrode of the fourteenth scan transistor ST14.

A sixteenth scan transistor ST16 of the plurality of scan transistors may be electrically connected between the second control node QB1 and the input terminal for applying the second low power supply voltage VCL2_GW. A gate electrode of the sixth scan transistor ST16 may be connected to the first control node Q. When the first control node Q has the turn-on voltage level, the sixteenth scan transistor ST16 may be turned on, to transmit the second low power supply voltage VCL2_GW to the second control node QB1.

When the first control node Q has the turn-on voltage level, the fifteenth scan transistor ST15 and the sixteenth scan transistor ST16 may maintain the second control node QB1 to be in the turn-off voltage level.

A seventeenth scan transistor ST17 of the plurality of scan transistors may be electrically connected between an input terminal for applying a second switching signal GW_GBI2 and a gate electrode of the eighteenth scan transistor ST18. A gate electrode of the seventeenth scan transistor ST17 may be connected to the input terminal for applying the second switching signal GW_GBI2. The seventeenth scan transistor ST17 may be turned on in response to the second switching signal GW_GBI2 having the turn-on voltage level, to transmit the second switching signal GW_GBI2 having the turn-on voltage level to the gate electrode of the eighteenth scan transistor ST18.

The seventeenth scan transistor ST17 may include a ninth sub-transistor ST17_1 and a tenth sub-transistor ST17_2 which are connected to each other in series between the input terminal for applying the second switching signal GW_GBI2 and the gate electrode of the eighteenth scan transistor ST18.

An eighteenth scan transistor ST18 of the plurality of scan transistors may be electrically connected between an input terminal for applying the second switching signal GW_GBI2 and the first control node Q. The eighteenth scan transistor ST18 may be turned on, in response to the second switching signal GW_GBI2 having the turn-on voltage level, to transmit the second switching signal GW_GBI2 having the turn-on voltage level to the first control node Q.

A third capacitor C3 of the capacitors may be electrically connected between the gate electrode of the eighteenth scan transistor ST18 and the first control node Q.

A nineteenth scan transistor ST19 of the plurality of scan transistors may be electrically connected between the gate electrode of the eighteenth scan transistor ST18 and the input terminal for applying the first low power supply voltage VCL_GW. A gate electrode of the nineteenth scan transistor ST19 may be connected to the first control node Q. When the first control node Q has the turn-on voltage level, the nineteenth scan transistor ST19 may be turned on, to transmit the first low power supply voltage VCL_GW to the gate electrode of the eighteenth scan transistor ST18.

A 20-th scan transistor ST20 of the plurality of scan transistors may be electrically connected between the third control node QB2 and the input terminal for applying the second low power voltage VCL2_GW. A gate electrode of the 20-th scan transistor ST20 may be connected to the first control node Q. When the first control node Q has the turn-on voltage level, the 20-th scan transistor ST20 may be turned on, to transmit the second low power supply voltage VCL2_GW to the third control node QB2.

When the first control node Q has the turn-on voltage level, the nineteenth scan transistor ST19 and the 20-th scan transistor ST20 may maintain the third control node QB2 to be in the turn-off voltage level.

The first switching signal GW_GBI1 and the second switching signal GW_GBI2 have different voltage levels and may be varied in a cycle of two frame durations. Each of the first switching signal GW_GBI1 and the second switching signal GW_GBI2 may have the turn-on voltage level for one frame duration and the turn-off voltage level for another frame duration.

For example, for the first frame duration, the first switching signal GW_GBI1 may have the turn-on voltage level, and the second switching signal GW_GBI2 may have the turn-off voltage level. For example, for the second frame duration, the first switching signal GW_GBI1 may have the turn-off voltage level, and the second switching signal GW_GBI2 may have the turn-on voltage level.

The second control node QB1 and the third control node QB2 alternately have the turn-on voltage level in a unit of a frame duration, and the fifth, sixth, eighth, ninth, eleventh and twelfth scan transistors ST5 ST6, ST8, ST9, ST11, and ST12 connected to the second control node QB1 and the third control node QB2 alternately operate in the unit of the frame duration. Accordingly, the stress for the scan transistors may be mitigated.

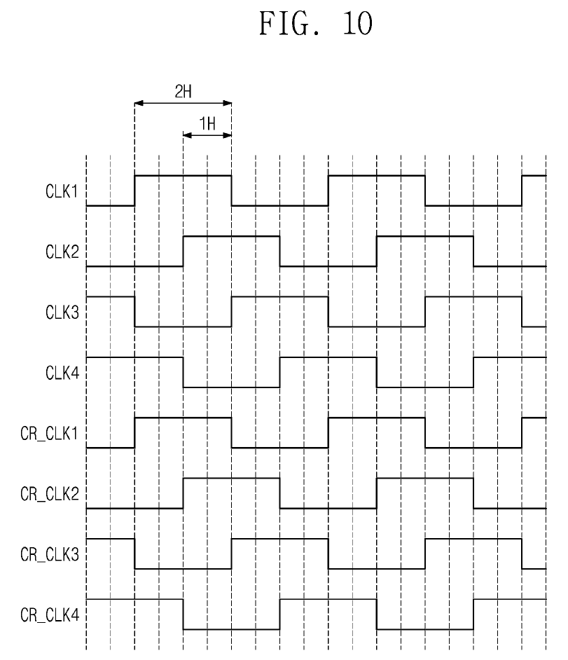

FIG. 10 is a waveform illustrating the driving of clock signals according to an embodiment.

Referring to FIGS. 8 and 10, each of the first clock signal CLK1, the second clock signal CLK2, the third clock signal CLK3, and the fourth clock signal CLK4 may be a square waveform having a turn-on voltage level or a turn-off voltage level. Each of the first clock signal CLK1, the second clock signal CLK2, the third clock signal CLK3, and the fourth clock signal CLK4 may oscillate between the turn-on voltage level and the turn-off voltage level in a specific cycle.

For example, each of the first clock signal CLK1, the second clock signal CLK2, the third clock signal CLK3, and the fourth clock signal CLK4 may have the turn-on voltage level for two horizontal periods (2H) and a turn-off voltage level for the two horizontal periods (2H).

Each of the first clock signal CLK1, the second clock signal CLK2, the third clock signal CLK3, and the fourth clock signal CLK4 may have 50% of a duty ratio.

The third clock signal CLK3 may have a waveform shifted by at least half a cycle from the first clock signal CLK1. For example, the third clock signal CLK3 may be shifted by two horizontal periods (2H) from the first clock signal CLK1.

The fourth clock signal CLK4 may have a waveform shifted by at least half a cycle from the second clock signal CLK2. For example, the fourth clock signal CLK4 may be shifted by two horizontal periods (2H) from the second clock signal CLK2.

The second clock signal CLK2 may have a waveform shifted by at least 1/4 of a cycle from the first clock signal CLK1. The second clock signal CLK2 may be superimposed on the first clock signal CLK1 by one horizontal period 1H.

According to embodiments, each of the first clock signal CLK1, the second clock signal CLK2, the third clock signal CLK3, and the fourth clock signal CLK4 may have waveforms corresponding to the first scan signals GW[1] to GW[4], respectively. The loads applied to the first to fourth clock signals CLK1 to CLK4 may be relatively reduced due to the arrangement relation between the plurality of scan clock lines CL1 to CL4 and the plurality of logic clock lines CRL1 to CLR4. The delay in the outputs of the first scan signals GW[1] to GW[2] may be improved. Accordingly, a charging rate of the data voltage Vdata (see FIG. 3) may be ensured. Accordingly, the electronic device 1000 (see FIG. 2) may be provided with reliability improved in the output of the first scan signals GW[1] to GW[4].

The first logic clock signal CR_CLK1, the second logic clock signal CR_CLK2, the third logic clock signal CR_CLK3, and the fourth logic clock signal CR_CLK4 may have waveforms corresponding to the first clock signal CLK1, the second clock signal CLK2, the third clock signal CLK3, and the fourth clock signal CLK4, respectively.

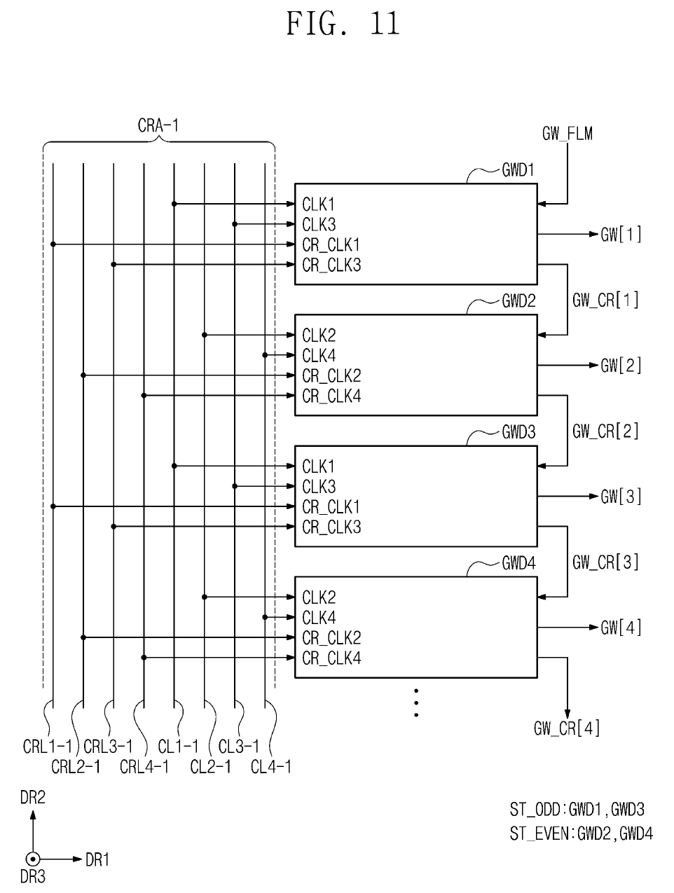

FIG. 11 is a schematic block diagram illustrating expanded region AA’ of a first driving circuit in FIG. 7 according to an embodiment. In the following description made with reference to FIG. 11, the components that are described with reference to FIG. 8 are assigned with the same reference numerals, and the details thereof will be omitted.

Referring to FIG. 11, the display panel DP (see FIG. 2) may further include a plurality of clock lines CL1-1 to CL4-1, and CRL1-1 to CRL4-1. The plurality of first scan stages GWD1, GWD2, GWD3, and GWD4 may be electrically connected to the plurality of clock lines CL1-1 to CL4-1, and CRL1-1 to CRL4-1.

The plurality of clock lines CL1-1 to CL4-1, and CRL1-1 to CRL4-1 may include the plurality of scan clock lines CL1-1 to CL4-1, and the plurality of logic clock lines CRL1-1 to CRL4-1.

The plurality of scan clock lines CL1-1 to CL4-1 may be adjacent to the plurality of first scan stages GWD1 to GWD4 in the first direction DR1. The plurality of scan clock lines CL1-1 to CL4-1 may be spaced apart from each other in the first direction DR1. Each of the plurality of scan clock lines CL1-1 to CL4-1 may extend in the second direction DR2.

The plurality of scan clock lines CL1-1 to CL4-1 may include the first scan clock line CL1-1 for applying the first clock signal CLK1, the second scan clock line CL2-1 for applying the second clock signal CLK2, the third scan clock line CL3-1 for applying the third clock signal CLK3, and the fourth scan clock line CL4-1 for applying the fourth clock signal CLK4.

The plurality of logic clock lines CRL1-1 to CRL4-1 may be spaced apart from the first scan stages GWD1 to GWD4 in the first direction. The plurality of scan clock lines CL1-1 to CL4-1 may be provided between the plurality of logic clock lines CRL1-1 to CRL4-1 and the first scan stages GWD1 to GWD4. The plurality of logic clock lines CRL1-1 to CRL4-1 may be spaced apart from each other in the first direction DR1. Each of the plurality of logic clock lines CRL1-1 to CRL4-1 may extend in the second direction DR2.

The plurality of logic clock lines CRL1-1 to CRL4-1 may include the first logic clock line CRL1-1 for applying the first logic clock signal CR_CLK1, the second logic clock line CRL2-1 for applying the second logic clock signal CR_CLK2, the third logic clock line CRL3-1 for applying the third logic clock signal CR_CLK3, and the fourth logic clock line CRL4-1 for applying the fourth logic clock signal CR_CLK4.

The plurality of scan clock lines CL1-1 to CL4-1 and the plurality of logic clock lines CRL1-1 to CRL4-1 may be disposed in an interconnection region CRA-1.

According to embodiments, the plurality of logic clock lines CRL1-1 to CRL4-1 may provide the plurality of logic clock signals CR_CLK1 to CR_CLK4 to the plurality of first scan stages GWD1 to GWD4 while crossing the plurality of scan clock lines CL1-1 to CL4-1 in the first direction DR1. As the plurality of scan clock lines CL1-1 to CL4-1 are adjacent to the plurality of first scan stages GWD1 to GWD4, the plurality of scan clock lines CL1-1 to CL4-1 may provide the plurality of clock signals CLK1 to CLK4 to the plurality of first scan stages GWD1 to GWD4, with a relatively small load. The first scan signals GW[1] to GW[4] may be output using the plurality of clock signals CLK1 to CLK4 applied to the plurality of scan clock lines CL1-1 to CL4-1, respectively. The delay in the outputs of the first scan signals GW[1] to GW[4] may be improved using the arrangement relation between the plurality of scan clock lines CL1-1 to CL4-1 and the plurality of logic clock lines CRL1-1 to CRL4-1. Accordingly, a charging rate of the data voltage Vdata (see FIG. 3) may be ensured. Accordingly, the electronic device 1000 (see FIG. 2) may be provided with reliability improved in the output of the first scan signals GW[1] to GW[4].

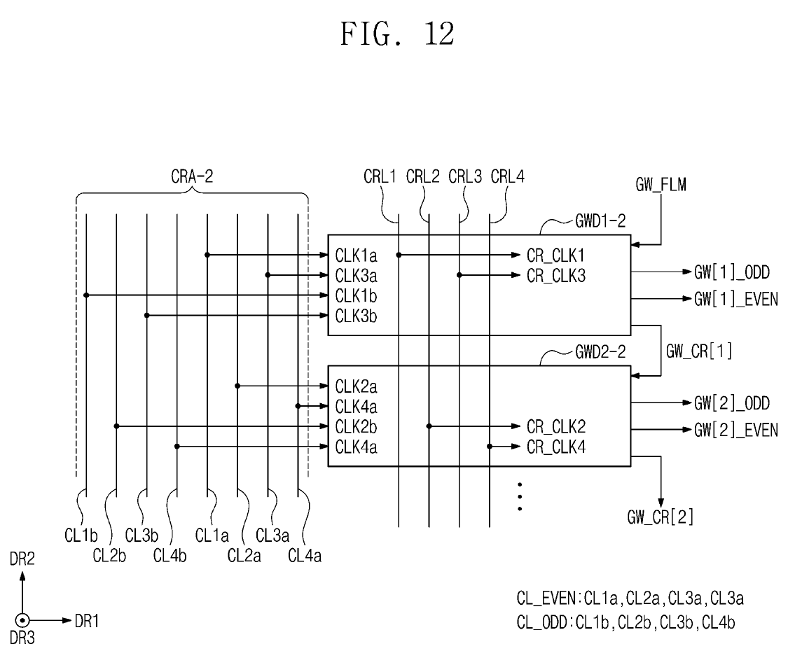

FIG. 12 is a schematic block diagram illustrating expanded region AA’ of a first driving circuit in FIG. 7 according to an embodiment. In the following description made with reference to FIG. 12, the components that are described with reference to FIG. 8 are assigned with the same reference numerals, and the details thereof will be omitted.

Referring to FIG. 12, the display panel DP (see FIG. 2) may further include a plurality of clock lines CL1a to CL4a, CL1b to CL4b, and CRL1 to CRL4. The plurality of first scan stages GWD1-2 to GWD2-2 may be electrically connected to the plurality of clock lines CL1a to CL4a, CL1b to CL4b, and CRL1 to CRL4.

The plurality of clock lines CL1a to CL4a, CL1b to CL4b, and CRL1 to CRL4 may include a plurality of first scan clock lines CL1a, CL2a, CL3a and CL4a, a plurality of second scan clock lines CL1b, CL2b, CL3b and CL4b, and the plurality of logic clock lines CRL1 to CRL4.

The plurality of first scan clock lines CL1a to CL4a may be adjacent to the plurality of first scan stages GWD1-2 to GWD2-2 in the first direction DR1. The plurality of first scan clock lines CL1a to CL4a may be spaced apart from each other in the first direction DR1. Each of the plurality of first scan clock lines CL1a to CL4a may extend in the second direction DR2. The plurality of first scan clock lines CL1a to CL4a may be referred to as even scan clock lines CL_EVEN.

The plurality of first scan clock lines CL1a to CL4a may include the (1-1)-th scan clock line CL1a for applying a (1-1)-th clock signal CLK1a, the (1-2)-th scan clock line CL2a for applying a (1-2)-th clock signal CLK2a, the (1-3)-th scan clock line CL3a for applying a (1-3)-th clock signal CLK3a, and the (1-4)-th scan clock line CL4a for applying a (1-4)-th clock signal CLK4a.

The plurality of second scan clock lines CL1b to CL4b may be spaced apart from the plurality of first scan stages GWD1-2 and GWD2-2 in the first direction DR1. The plurality of first scan clock lines CL1a to CL4a may be provided between the plurality of second scan clock lines CL1b to CL4b and the plurality of first scan stages GWD1-2 and GWD2-2. The plurality of second scan clock lines CL1b to CL4b may be spaced apart from each other in the first direction DR1. Each of the plurality of second scan clock lines CL1b to CL4b may extend in the second direction DR2. The plurality of second scan clock lines CL1b to CL4b may be referred to as the odd scan clock lines CL_ODD.

The plurality of second scan clock lines CL1b to CL4b may include the (2-1)-th scan clock line CL1b for applying a (2-1)-th clock signal CLK1b, the (2-2)-th scan clock line CL2b for applying a (2-2)-th clock signal CLK2b, the (2-3)-th scan clock line CL3b for applying a (2-3)-th clock signal CLK3b, and the (2-4)-th scan clock line CL4b for applying a (2-4)-th clock signal CLK4b.

The plurality of first scan clock lines CL1a to CL4a and the plurality of second scan clock lines CL1b to CL4b may be disposed in an interconnection region CRA-2.

The (1-1)-th scan stage GWD1-2 may be electrically connected to the (1-1)-th and (1-3)-th scan clock lines CL1a and CL3a, the (2-1)-th and (2-3)-th scan clock lines CL1b and CL3b, and the first and third logic clock lines CRL1 and CRL3. The (1-1)-th scan stage GWD1-2 may receive the (1-1)-th and (3-1)-th clock signals CLK1a and CLK3a, the (2-1)-th and the (2-3)-th clock signals CLK1b and CLK3b, or the first and third logic clock signals CR_CLK1 and CR_CLK3.

The (1-2)-th scan stage GWD2-2 may be electrically connected to the (1-2)-th and (1-4)-th scan clock lines CL2a and CL4a, the (2-2)-th and the (2-4)-th scan clock lines CL2b and CL4b, and the second and fourth logic clock lines CRL2 and CRL4. The (1-2)-th scan stage GWD2-2 may receive the (1-2)-th and the (1-4)-th clock signals CLK2a and CLK4a, the (2-2)-th and the (2-4)-th clock signals CLK2b and CLK4b, and the second and fourth logic clock signals CR_CLK2 and CR_CLK4.

The (1-1)-th scan stage GWD1-2 may output the (1-3)-th clock signal CLK3a as a (1-1)-th even scan signal GW[1]_EVEN, in response to the first scan start signal GW_FLM.

Alternatively, the (1-1)-th scan stage GWD1-2 may output the (2-3)-th clock signal CLK3b as a (1-1)-th odd scan signal GW[1]_ODD, in response to the first scan start signal GW_FLM.

The (1-1)-th scan stage GWD1-2 may output the third logic clock signal CR_CLK3 as a first carry signal GW_CR[1].

The (1-2)-th scan stage GWD2-2 may output the (1-4)-th clock signal CLK4a as a (1-2)-th even scan signal GW[2]_EVEN, in response to the first carry signal GW_CR[1].

The (1-2)-th scan stage GWD2-2 may output the (2-4)-th clock signal CLK4b as a (1-2)-th odd scan signal GW[2]_ODD, in response to the first carry signal GW_CR[1].

The (1-2)-th scan stage GWD2-2 may output the fourth logic clock signal CR_CLK4 as a second carry signal GW_CR[2].

The (1-1)-th odd scan signal GW[1]_ODD, the (1-1)-th even scan signal GW[1]_EVEN, the (1-2)-th odd scan signal GW[2]_ODD, and the (1-2)-th even scan signal GW[2]_EVEN may be sequentially output.

According to embodiments, the plurality of first scan clock lines CL1a to CL4a and the plurality of second scan clock lines CL1b to CL4b may be disposed to be adjacent to the plurality of first scan stages GWD1-2 to GWD2-2. The plurality of first scan clock lines CL1a to CL4a and the plurality of second scan clock lines CL1b to CL4b may have a load less than a load of the plurality of logic clock lines CRL1 to CRL4 overlapped (i.e., in a plan view) with the plurality of first scan stages GWD1-2 to GWD2-2. The delay in the outputs of the first scan signals GW[1]_ODD, GW[1]_EVEN, GW[2]_ODD, and GW[2]_EVEN may be improved using the arrangement relation between the plurality of first scan clock lines CL1a to CL4a, the plurality of second scan clock lines CL1b to CL4b, and the plurality of logic clock lines CRL1 to CRL4. Accordingly, a charging rate of the data voltage Vdata (see FIG. 3) may be ensured. Accordingly, the electronic device 1000 (see FIG. 2) may be provided with reliability improved in the output of the first scan signals GW[1]_ODD, GW[1]_EVEN, GW[2]_ODD, and GW[2]_EVEN.

According to embodiments, the plurality of first scan clock lines CL1a to CL4a, and the plurality of second scan clock lines CL1b to CL4b may be provided in the same layer. The difference in output between the plurality of first clock signals CLK1a to CLK4a and the plurality of second clock signals CLK1b to CLK4b may be reduced. The first scan signals GW[1]_ODD, GW[1]_EVEN, GW[2]_ODD, and GW[2]_EVEN may be output based on the plurality of first clock signals CLK1a to CLK4a and the plurality of second clock signals CLK1b to CLK4b. Accordingly, the electronic device 1000 (see FIG. 2) may be provided with reliability improved in the output of the first scan signals GW[1]_ODD, GW[1]_EVEN, GW[2]_ODD, and GW[2]_EVEN.

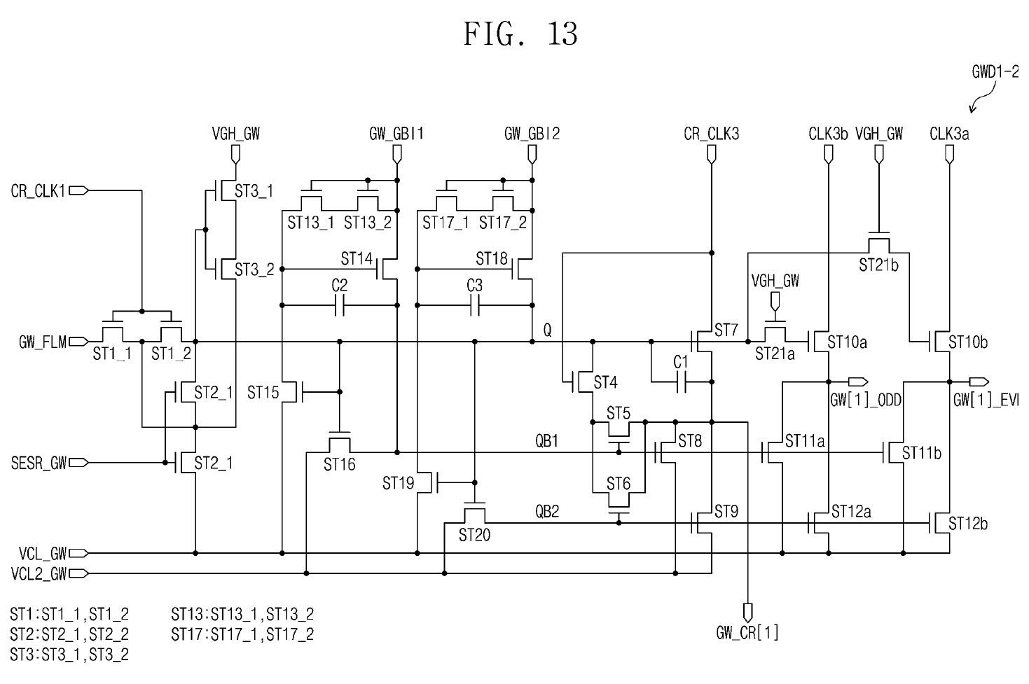

FIG. 13 is a schematic equivalent circuit diagram illustrating a first scan stage according to an embodiment. In the following description made with reference to FIG. 13, the components that are described with reference to FIG. 9 are assigned with the same reference numerals, and the details thereof will be omitted.

Referring to FIGS. 12 and 13, the (1-1)-th scan stage GWD1-2 may include a plurality of scan transistors ST1, ST2, ST3, ST4, ST5, ST6, ST7, ST8, ST9, ST10a, ST10b, ST11a, ST11b, ST12a, ST12b, ST13, ST14, ST15, ST16, ST17, ST18, ST19, ST20, ST21a, and ST21b, and capacitors C1 to C3.

The (10-1)-th scan transistor ST10a may be electrically connected between an input terminal for applying the (2-3)-th clock signal CLK3b and a scan output terminal for outputting the first odd scan signal GW[1]_ODD. A gate electrode of the (10-1)-th scan transistor ST10a may be connected to the first control node Q. When the first control node Q has the turn-on voltage level, the (10-1)-th scan transistor ST10a may be turned on, and may output the (2-3)-th clock signal CLK3b as the first odd scan signal GW[1]_ODD.

The (11-1)-th scan transistor ST11a may be electrically connected between the input terminal for applying the first low power supply voltage VCL_GW and the scan output terminal. A gate electrode of the (11-1)-th scan transistor ST11a may be electrically connected to the second control node QB1. When the second control node QB1 has the turn-on voltage level, the (11-1)-th scan transistor ST11a may be turned on, and the first odd scan signal GW[1]_ODD may be pulled down to the first low power supply voltage VCL_GW.

The (12-1)-th scan transistor ST12a may be connected in parallel to the (11-1)-th scan transistor ST11a. The (12-1)-th scan transistor ST12a may be electrically connected between the input terminal for applying the first low power supply voltage VCL_GW and the scan output terminal. A gate electrode of the (12-1)-th scan transistor ST12a may be electrically connected to the third control node QB2. When the third control node QB2 has the turn-on voltage level, the (12-1)-th scan transistor ST12a may be turned on, and the first odd scan signal GW[1]_ODD may be pulled down to the first low power supply voltage VCL_GW.

The (21-1)-th scan transistor ST21a may be electrically connected between the first control node Q and the gate electrode of the (10-1)-th scan transistor T10a. A gate electrode of the (21-1)-th scan transistor ST21a may be connected to the input terminal for the high power supply voltage VGH_GW.

The (10-2)-th scan transistor ST10b may be electrically connected between an input terminal for applying the (1-3)-th clock signal CLK3a and a scan output terminal for output the first even scan signal GW[1]_EVEN. A gate electrode of the (10-2)-th scan transistor ST10b may be connected to the first control node Q. When the first control node Q has the turn-on voltage level, the (10-2)-th scan transistor ST10b may be turned on, and may output the (1-3)-th logic clock signal CLK3a as the first even scan signal GW[1]_EVEN.

The (11-2)-th scan transistor ST11b may be electrically connected between the input terminal for applying the first low power supply voltage VCL_GW and the scan output terminal for output the first even scan signal GW[1]_EVEN. A gate electrode of the (11-2)-th scan transistor ST11b may be electrically connected to the second control node QB1. When the second control node QB1 has the turn-on voltage level, the (11-2)-th scan transistor ST11b may be turned on, and the first even scan signal GW[1]_EVEN may be pulled down to the first low power supply voltage VCL_GW.

The (12-2)-th scan transistor ST12b may be connected in parallel to the (11-2)-th scan transistor ST11b. The (12-2)-th scan transistor ST12b may be electrically connected between the input terminal for applying the first low power supply voltage VCL_GW and the scan output terminal for output the first even scan signal GW[1]_EVEN. A gate electrode of the (12-2)-th scan transistor ST12b may be electrically connected to the third control node QB2. When the third control node QB2 has the turn-on voltage level, the (12-2)-th scan transistor ST12b may be turned on, and the first even scan signal GW[1]_EVEN may be pulled down to the first low power supply voltage VCL_GW.

The (21-2)-th scan transistor ST21b may be electrically connected between the first control node Q and the gate electrode of the (10-2)-th scan transistor T10b. A gate electrode of the (21-2)-th scan transistor ST21b may be connected to the input terminal for applying the high power supply voltage VGH_GW.

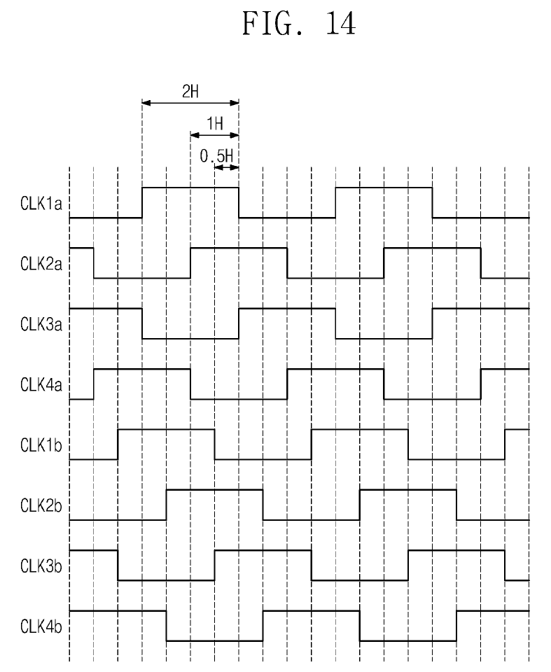

FIG. 14 is a waveform illustrating the driving of clock signals according to an embodiment.

Referring to FIGS. 12 and 14, each of the plurality of first clock signals CLK1a to CLK4a, and the plurality of second clock signals CLK1b to CLK4b may have a square waveform having a turn-on voltage level or a turn-off voltage level. Each of the plurality of first clock signals CLK1a to CLK4a, and the plurality of second clock signals CLK1b to CLK4b may oscillate between the turn-on voltage level and the turn-off voltage level in a specific cycle.

For example, each of the plurality of first clock signals CLK1a to CLK4a, and the plurality of second clock signals CLK1b to CLK4b may have the turn-on voltage level for two horizontal periods (2H) and the turn-off voltage level for the two horizontal periods (2H).

Each of the plurality of first clock signals CLK1a to CLK4a and the plurality of second clock signals CLK1b to CLK4b may have 50% of a duty ratio.

The (1-3)-th clock signal CLK3a may have a waveform shifted by at least half a cycle from the (1-1)-th clock signal CLK1a. For example, the (1-3)-th clock signal CLK3a may be shifted by the two horizontal periods (2H) from the (1-1)-th clock signal CLK1a.

The (1-4)-th clock signal CLK4a may have a waveform shifted by at least half a cycle from the (1-2)-th clock signal CLK2a. For example, the (1-4)-th clock signal CLK4a may be shifted by the two horizontal periods (2H) from the (1-2)-th clock signal CLK2a.

The (1-2)-th clock signal CLK2a may have a waveform shifted by at least 1/4 of a cycle from the (1-1)-th clock signal CLK1a. The (1-2)-th clock signal CLK2a may be superimposed on the (1-1)-th clock signal CLK1a by one horizontal period (1H).

The (2-1)-th clock signal CLK1b may have a waveform shifted by at least 1/8 of a cycle from the (1-1)-th clock signal CLK1a. The (1-1)-th clock signal CLK1a may be shifted by 0.5 times the horizontal period (0.5H) from the (2-1)-th clock signal CLK1b.

The (2-3)-th clock signal CLK3b may have a waveform shifted by at least half a cycle from the (2-1)-th clock signal CLK1b. For example, the (2-3)-th clock signal CLK3b may be shifted by two horizontal periods (2H) from the (2-1)-th clock signal CLK1b.

The (2-4)-th clock signal CLK4b may have a waveform shifted by at least half a cycle from the (2-2)-th clock signal CLK2b. For example, the (2-4)-th clock signal CLK4b may be shifted by two horizontal periods (2H) from the (2-2)-th clock signal CLK2b.

The (2-2)-th clock signal CLK2b may have a waveform shifted by at least 1/4 of a cycle from the (2-1)-th clock signal CLK1b. The (2-2)-th clock signal CLK2b may be superimposed on the (2-1)-th clock signal CLK1b by one horizontal period (1H).

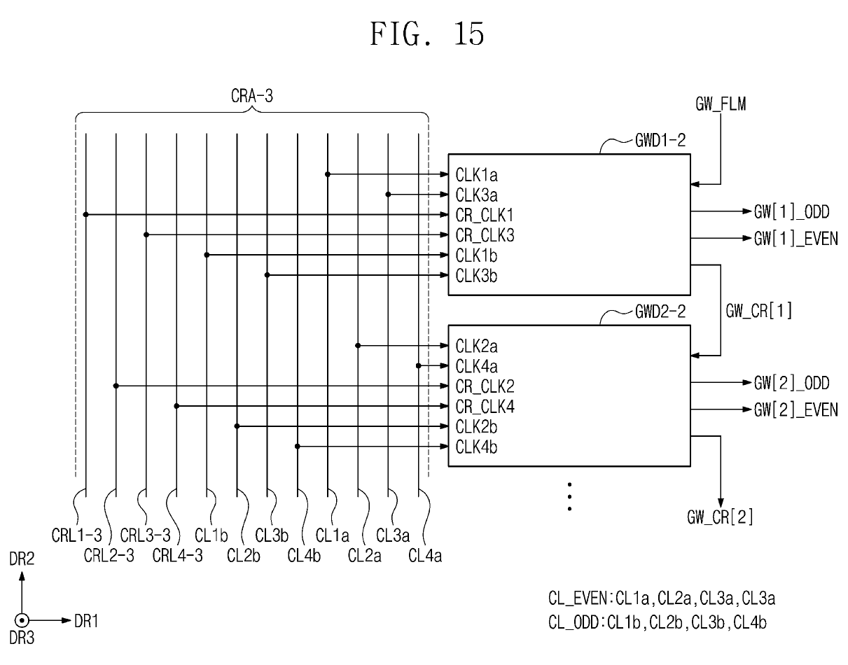

FIG. 15 is a schematic block diagram illustrating expanded region AA’ of a first driving circuit in FIG. 7 according to an embodiment. In the following description made with reference to FIG. 15, the components that are described with reference to FIGS. 8 and 12 are assigned with the same reference numerals, and the details thereof will be omitted.

Referring to FIG. 15, the display panel DP (see FIG. 2) may further include a plurality of clock lines CL1a to CL4a, CL1b to CL4b, and CRL1-3 to CRL4-3. The plurality of first scan stages GWD1-2 and GWD2-2 may be electrically connected to the plurality of clock lines CL1a to CL4a, CL1b to CL4b, and CRL1-3 to CRL4-3.

The plurality of clock lines CL1a to CL4a, CL1b to CL4b, and CRL1-3 to CRL4-3 may include the plurality of first scan clock lines CL1a to CL4a, the plurality of second scan clock lines CL1b to CL4b, and the plurality of logic clock lines CRL1-3 to CRL4-3.

The plurality of logic clock lines CRL1-3 to CRL4-3 may be spaced apart from the plurality of first scan clock lines CL1a to CL4a in the first direction DR1. The plurality of second scan clock lines CL1b to CL4b may be provided between the plurality of logic clock lines CRL1-3 to CRL4-3, and the plurality of first scan clock lines CL1a to CL4a. The plurality of logic clock lines CRL1-3 to CRL4-3 may be spaced apart from each other in the first direction DR1. Each of the plurality of logic clock lines CRL1-3 to CRL4-3 may extend in the second direction DR2.

The plurality of logic clock lines CRL1-3 to CRL4-3 may include the first scan clock line CRL1-3 for applying the first logic clock signal CR_CLK1, the second scan clock line CRL2-3 for applying the second logic clock signal CR_CLK2, the third scan clock line CRL3-3 for applying the third logic clock signal CR_CLK3, and the fourth scan clock line CRL4-3 for applying the fourth logic clock signal CR_CLK4.

The plurality of first scan clock lines CL1a to CL4a, the plurality of second scan clock lines CL1b to CL4b, and the plurality of logic clock lines CRL1-3 to CRL4-3 may be disposed in an interconnection region CRA-3.

According to embodiments, the plurality of logic clock lines CRL1-3 to CRL4-3 may provide the plurality of logic clock signals CR_CLK1 to CR_CLK4 to the plurality of first scan stages GWD1-2 and GWD2-2, through signal providing lines overlapped (i.e., in a plan view) with the plurality of first scan clock lines CL1a to CL14a, and the plurality of second scan clock lines CL1b to CL4b. The plurality of first scan clock lines CL1a to CL14a, and the plurality of second scan clock lines CL1b to CL4b may be adjacent to the plurality of first scan stages GWD1-2 and GWD2-2, and may provide the plurality of clock signals CLK1a to CLK4a and CLK1b to CLK4b to the plurality of first scan stages GWD1-2 and GWD2-2 with a reduced load. The first scan signals GW[1]_ODD, GW[1]_EVEN, GW[2]_ODD, and GW[2]_EVEN may be output using the plurality of clock signals CLK1a to CLK4a, and CLK1b to CLK4b. The delay in the outputs of the first scan signals GW[1]_ODD, GW[1]_EVEN, GW[2]_ODD, and GW[2]_EVEN may be improved using the arrangement relation among the plurality of first scan clock lines CL1a to CL14a, the plurality of second scan clock lines CL1b to CL4b, and the plurality of logic clock lines CRL1-3 to CRL4-3. Accordingly, a charging rate of the data voltage Vdata (see FIG. 3) may be ensured. Accordingly, the electronic device 1000 (see FIG. 2) may be provided with reliability improved in the output of the first scan signals GW[1]_ODD, GW[1]_EVEN, GW[2]_ODD, and GW[2]_EVEN.

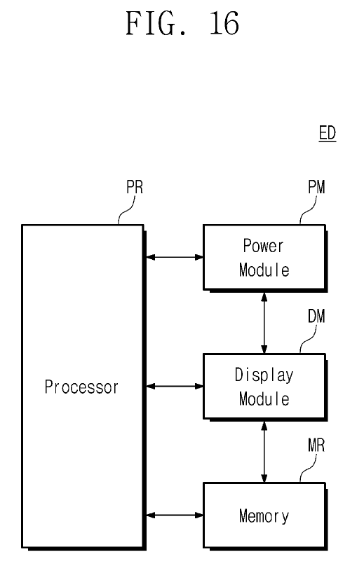

FIG. 16 is a block diagram of an electronic device according to an embodiment.

An electronic device according to embodiments may be provided in various forms. The electronic device according to embodiments may further include a module or a device having various additional functions.

Referring to FIG. 16, an electronic device ED according to an embodiment may include a display module DM, a processor PR, a memory MR, and a power module PM.

The processor PR may include at least one of a central processing unit (CPU), an application processor (AP), a graphic processing unit (GPU), a communication processor (CP), an image signal processor (ISP), or a controller. The processor PR may control the power module PM, the display module DM, and the memory MR.

The memory MR may store data information necessary for the operation of the processor PR or the display module DM. When the processor PR runs the application stored in the memory MR, an image data signal and/or an input control signal may be transmitted to the display module DM, and the display module DM may process the transmitted signal and output the image information through the display screen.

The power module PM may include a power converting module to convert power supplied from a power supply module such as a power adaptor or a battery device, into power necessary for the operation of the electronic device ED.

The display module DM may operate in response to an electrical signal. Some of individual modules functionally included in one module may be included in the display module DM, and other modules of the individual modules may be provided in the electronic device ED, separately from the display module DM. The display module DM may include the display panel DP (see FIG. 2) and the display driver 100C (see FIG. 2).

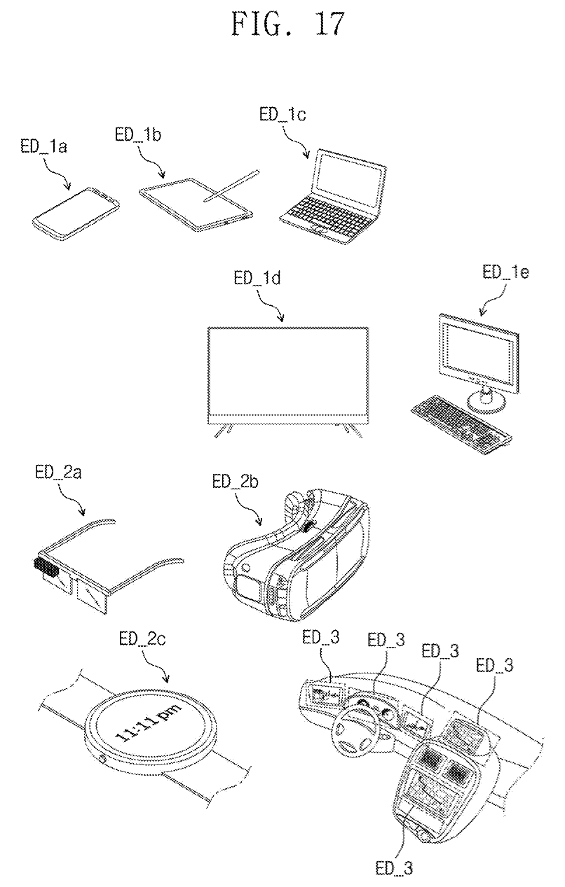

FIG. 17 is a schematic view illustrating an electronic device according to various embodiments.

Referring to FIG. 17, the electronic device according to various embodiments may be a wearable electronic device such as smart glasses ED_2a, a head mounted display ED_2b, and a smart watch ED_2c, as well as an electronic device for image display, such as a smartphone ED_1a, a tablet PC ED_1b, a laptop computer ED_1c, a television ED_1d and a desk monitor ED_1e.

In addition, the electronic device according to various embodiments is applied to an interior of a transport device such as a vehicle to provide, for a user, various pieces of information through an image. For example, a storage device according to embodiments may be provided in the form of an electronic device ED-3 for the vehicle including the display module such as a center information display (CID), which is disposed in an instrument panel, a center fascia and a dashboard of a vehicle, or a room mirror display.

As described above, the plurality of scan clock lines may be disposed to be adjacent to the plurality of first scan stages. The plurality of scan clock lines may have a load less than the plurality of logic clock lines overlapped (i.e., in a plan view) with the plurality of first scan stages. The first scan signals may be output using the plurality of clock signals provided to the plurality of scan clock lines, respectively. The delay in outputs of the first scan signals may be improved due to the arrangement relation between the plurality of scan clock lines, and the plurality of logic clock lines. Accordingly, the charging rate of the data voltage may be ensured. Accordingly, the electronic device may be provided with reliability improved in the output of the first scan signals.

In some embodiments, each of the components represented by a block as illustrated in FIGS. 1, 2, 5-8, 11, 12 and 15-17 may be implemented as various numbers of hardware and/or firmware structures that execute respective functions described above, according to embodiments. For example, at least one of these components may include various hardware components including a digital circuit, a programmable or non-programmable logic device or array, an application specific integrated circuit (ASIC), transistors, capacitors, logic gates, or other circuitry using use a direct circuit structure, such as a memory, a processor, a logic circuit, a look-up table, etc., that may execute the respective functions through controls of one or more microprocessors or other control apparatuses. Also, at least one of these components may further include or may be implemented by a processor such as a central processing unit (CPU) that performs the respective functions, a microprocessor, or the like. Functional aspects of example embodiments may be implemented in algorithms that execute on one or more processors. Furthermore, the components, elements, modules or units represented by a block or processing steps may employ any number of related art techniques for electronics configuration, signal processing and/or control, data processing and the like.

Although embodiments been described for illustrative purposes, those skilled in the art will appreciate that various modifications, and substitutions are possible, without departing from the scope and spirit of the present disclosure as disclosed in the accompanying claims. Accordingly, the technical scope of the present disclosure is not limited to the detailed description of this specification, but should be defined by the claims.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An electronic device comprising:
a display panel; and
a processor configured to control the display panel,
wherein the display panel comprises:
a plurality of pixels connected to a plurality of data lines and a plurality of scan lines, respectively;
a plurality of scan stages connected to the plurality of scan lines, respectively; and
a plurality of clock lines connected to the plurality of scan stages, respectively,
wherein the plurality of pixels are configured to receive a corresponding data voltage, in response to a corresponding scan signal,
wherein a first scan stage of the plurality of scan stages is configured to receive a logic clock signal, a clock signal, and a carry signal, and output a scan signal,
wherein the plurality of clock lines comprise a logic clock line configured to provide the logic clock signal and a scan clock line configured to provide the clock signal,
wherein the scan clock line is adjacent the plurality of scan stages along a first direction, when viewed in a plan view,
wherein the plurality of clock lines extend in a second direction crossing the first direction, and
wherein the logic clock line is spaced apart from the scan clock line along the first direction, when viewed in the plan view.

2. The electronic device of claim 1, wherein the scan clock line is offset from the plurality of scan stages, when viewed in the plan view.

3. The electronic device of claim 1, wherein the logic clock line overlaps the plurality of scan stages, when viewed in the plan view.

4. The electronic device of claim 3, wherein the logic clock line is on the plurality of scan stages.

5. The electronic device of claim 1, wherein the logic clock signal has a square waveform which oscillates between a turn-on voltage level and a turn-off voltage level at a specific cycle.

6. The electronic device of claim 1, wherein the first scan stage is further configured to output the clock signal as the scan signal, in response to the carry signal.

7. The electronic device of claim 6, wherein the first scan stage is further configured to output the logic clock signal as the carry signal to be provided to a second scan stage, of the plurality of scan stages, in response to the carry signal.

8. The electronic device of claim 1, wherein the logic clock line is spaced apart from the plurality of scan stages in the first direction, and the scan clock line is between the logic clock line and the plurality of scan stages, when viewed in the plan view.

9. The electronic device of claim 1, wherein the clock signal comprises a first clock signal and a second clock signal different from the first clock signal, and
wherein the scan clock line comprises:
a first scan clock line configured to provide the first clock signal; and
a second scan clock line configured to provide the second clock signal.

10. The electronic device of claim 9, wherein the second scan clock line is spaced apart from the plurality of scan stages, and the first scan clock line is between the second scan clock line and the plurality of scan stages.

11. The electronic device of claim 9, wherein the second clock signal has a waveform shifted by a specific period from the first clock signal.

12. An electronic device comprising:
a plurality of scan stages, wherein a first scan stage of the plurality of scan stages is configured to receive a logic clock signal, a clock signal, and a carry signal, and output a scan signal; and
a plurality of clock lines connected to the plurality of scan stages, respectively,
wherein the plurality of clock lines comprise a logic clock line configured to provide the logic clock signal to the first scan stage and a scan clock line configured to provide the clock signal to the first scan stage, and
wherein when viewed in a plan view, the logic clock line overlaps the plurality of scan stages, and the scan clock line is offset from the plurality of scan stages.

13. The electronic device of claim 12, wherein the logic clock line is on the plurality of scan stages.

14. The electronic device of claim 12, wherein the logic clock signal has a square waveform which oscillates between a turn-on voltage level and a turn-off voltage level at a specific cycle.

15. The electronic device of claim 12, wherein the first scan stage is further configured to output the clock signal as the scan signal, in response to the carry signal.

16. The electronic device of claim 15, wherein the first scan stage is further configured to output the logic clock signal as the carry signal to be provided to a second scan stage of the plurality of scan stages, in response to the carry signal.

17. The electronic device of claim 12, wherein the clock signal comprises a first clock signal and a second clock signal different from the first clock signal.

18. The electronic device of claim 17, wherein the scan clock line comprises:
a first scan clock line configured to provide the first clock signal; and
a second scan clock line configured to provide the second clock signal.

19. The electronic device of claim 18, wherein the second scan clock line is spaced apart from the plurality of scan stages, and the first scan clock line is between the second scan clock line and the plurality of scan stages.

20. The electronic device of claim 17, wherein the second clock signal has a waveform shifted by a specific period from the first clock signal.
